(19) United States
(12) Patent Application Publication
(10) Pub. No.: US 2013/0138572 A1
(43) Pub. Date: May 30, 2013

(54) System and Method for Generating Student Activity Flows in a University

(71) Applicants: Sridhar Varadarajan, Bangalore (IN); Preethy Iyer, Bangalore (IN); Meera Divya Munipalli Venugopal, Banglore (IN)

(72) Inventors: Sridhar Varadarajan, Bangalore (IN); Preethy Iyer, Bangalore (IN); Meera Divya Munipalli Venugopal, Banglore (IN)

(73) Assignee: SRM Institute of Technology, Chennai (IN)

(21) Appl. No.: 13/404,941

(22) Filed: Feb. 24, 2012

(30) Foreign Application Priority Data
Nov. 30, 2011 (IN) 4157/CHE/2011

(51) Int. Cl. G06Q 50/20

(52) U.S. Cl. 705/326

(57) ABSTRACT

An educational institution (also referred as a university) is structurally modeled using a university model graph. A key benefit of modeling of the educational institution is to help in an introspective analysis by the educational institute. In order to build an effective university model graph, it is required to gather and analyze the various activities performed on the university campus by the various entities of the university. A system and method for automated generation of activity flows involves analysis of multiple student specific sub-activities and correlating them from temporal and spatial points of view. Specifically, the presented system allows for reliable identification of activity flows accounting for duplicate and missing sub-activities.

1. A reference is made to the applicants' earlier Indian patent application titled “System and Method for an Influence based Structural Analysis of a University” with the application number 1269/CHE2010 filed on 6 May 2010.

2. A reference is made to another of the applicants' earlier Indian patent application titled “System and Method for Constructing a University Model Graph” with an application number 1809/CHE/2010 and filing date of 28 Jun. 2010.

3. A reference is made to yet another of the applicants' earlier Indian patent application titled “System and Method for University Model Graph based Visualization” with the application number 1848/CHE/2010 dated 30. Jun. 2010.

4. A reference is made to yet another of the applicants' earlier Indian patent application titled “System and method for what-if analysis of a university based on university model graph” with the application number 3203/CHE/2010 dated 28 Oct. 2010.

5. A reference is made to yet another of the applicants' earlier Indian patent application titled “System and method for comparing universities based on their university model graphs” with the application number 3492/CHE/2010 dated 22 Nov. 2010.

6. A reference is made to the applicant's copyright document titled “Activity and Interaction based Holistic Student Modeling in a University: ARIEL UNIVERSITY STUDENT Process Document” that is being forwarded under The Registrar of Copyright, Copyright Office, New Delhi.

7. A reference is made to yet another of the applicants' earlier Indian patent application titled “System and Method for Student Activity Gathering in a University” that is in the process of being filed.

### FIELD OF THE INVENTION

The present invention relates to the analysis of the information about a university in general, and more particularly, the analysis of the activities of the university associated with structural representations. Still more particularly, the present invention relates to a system and method for automatic generation of activity flows associated with the university.

1. Background of the Invention

An Educational Institution (E1) (also referred as University) comprises of a variety of entities: students, faculty members, departments, divisions, labs, libraries, special interest groups, etc. University portals provide information about the universities and act as a window to the external world. A typical portal of a university provides information related to (a) Goals, Objectives, Historical Information, and Significant Milestones, of the university; (b) Profile of the Labs, Departments, and Divisions; (c) Profile of the Faculty Members; (d) Significant Achievements; (e) Admission Procedures; (f) Information for Students; (g) Library; (h) On- and Off-Campus Facilities; (i) Research; (j) External Collaborations; (k) Information for Collaborators; (I) News and Events; (m) Alumni; and (n) Information Resources. The educational institutions are positioned in a very competitive environment and it is a constant endeavor of the management of the educational institution to ensure to be ahead of the competition. This calls for a critical analysis of the overall functioning of the university and help suggest improvements so as enhance the overall strength aspects and overcome the weaknesses. Consider a typical scenario of assessing of a student of the Educational Institution. In order to achieve a holistic assessment, it is required to assess the student not only based on the curricular activities but also those other but related activities. This requires the generation of the activity flows associated with a student and to use them appropriately in the holistic assessment process.

2. Description of Related Art

U.S. Pat. No. 7,853,465 to Molesky; Lory Dean (Lexington, Mass.) for “Methods and apparatus to present event information with respect to a timeline” (issued on Dec. 14, 2010 and assigned to Oracle International Corp. (Redwood Shores, Calif.)) describes a charting application that generates a so-called timelink chart with respect to timeline axis and business event axis.

U.S. patent application Ser. No. 11/533,733 titled “Automated Workflow Composable Action Model” by Teegan; Hugh A.; (Bellevue, Wash.); Aziz; Imran; (Seattle, Wash.); Kalra; Vishal; (Redmond, Wash.); Wong; Kong-Kat; (Beijing, CN) (filed on Sep. 20, 2006 and assigned to Microsoft Corporation, Redmond, Wash.) describes an automated workflow composable action model that allows composition of actions into an activity flow wherein the activity flows can be based on an activity model, created on an ad hoc basis, or a combination of the two.

U.S. patent application Ser. No. 11/304,667 titled “Establishment and execution system for enterprise activity management systems” by Chen; Jung-Hsiang; (Taipei, TW); Chen; Cheng-Szu; (Taipei, TW); Yeh; Chang-Ching; (Taipei, TW); Chen; Chien-Jung; (Taipei, TW); Chen; Cher Jung; (Taipei, TW); Huang; Sheng-Huei; (Taipei, TW); Hu; Po-Sheng; (Taipei, TW) (filed on Jun. 28, 2007 and assigned to Sagatek Co., Ltd. Taipei, TW) describes an enterprise activity flow planning system and an enterprise activity flow execution system that allow users to define flows of a plurality of enterprise activities, to establish enterprise activity management systems, and to execute the established enterprise activity management systems.

“A State Machine Based Coordination Model applied to Workflow Applications” by Mario Sanchez, Jorge Villalobos, and Daniel Romero (appeared in the Proceedings of the 4th Congreso Colombiano de Computación, Bucaramanga, Colombia, April, 2009) presents a platform to build workflow applications supporting multiple dimensions and an executable model is used for each dimension, and these executable models are expressed with a coordination model based on synchronized state machines.

“WebWorkFlow: An Object-Oriented Workflow Modeling Language for Web Applications” by Zef Hemel, Ruben Verhaaf, and Eelco Visser (appeared in the Proceedings of the MoDELS 2008, LNCS 5301, pp. 113-127, 2008, (K. Czarnecki et al. (Eds.)), Springer-Verlag Berlin Heidelberg 2008) describes an object-oriented workflow modeling language for the high-level description of workflows in web applications and workflow descriptions define procedures operating on domain objects.

“The Machine Translation Toolpack for LoonyBin: Automated Management of Experimental Machine Translation HyperWorkflows ” by Jonathan H. Clark, Jonathan Weese, Byung Gyu Ahn, Andreas Zollmann, Qin Gao, Kenneth Heafield, and Alon Lavie (appeared in The Prague Bulletin of Mathematical Linguistics, 2009, pp 1-10) addresses the issues of the construction of machine translation systems based on multi-stage workflows involving many complicated dependencies.

The known systems do not address the issue of student activity flow generation in the university context. The present invention provides for a system and method for generating of the well-defined activity flows of students based on their so-called sub-activities in a university so as to be of assistance in the holistic assessment of the students.

Please note that in the following activity flows and act-flows are used interchangeably.

### SUMMARY OF THE INVENTION

The primary objective of the invention is to generate act-flows based on the gathered activities of a student in the context of a university.

One aspect of the invention is to correlate the location information across a set of related sub-activities of the student.

Another aspect of the invention is to correlate the mode information across an act-flow associated with the student.

Yet another aspect of the invention is to assess the act-flow associated with the student based on an aspect measure.

Another aspect of the invention is to assess the act-flow associated with the student based on an aspect model.

Yet another aspect of the invention is to assess the act-flow associated with the student based on an interaction model.

In a preferred embodiment, the present invention provides a system for generating a plurality of assessed act-flows based on a plurality of sub-activities of a student of a university based on a plurality of act-flow models, wherein said system comprising:
a sub-system (365-1) for determining a plurality of completely traversed act-flows based on said plurality of sub-activities and said plurality of act-flow models;
a sub-system (375-1) for selecting a best matching act-flow based on said plurality of completely traversed act-flows;
a sub-system (380-1) for assessing said best matching act-flow of said plurality of act-flows based on an aspect measure associated with said best match act-flow to result in an assessed act-flow of said plurality of assessed act-flows associated with an assessed measure;
a sub-system (385-1) for assessing said best matching act-flow of said plurality of act-flows based on an aspect model associated with said best matching act-flow to result in an assessed act-flow of said plurality of assessed act-flows associated with an assessed model measure; and
a sub-system (390-1) for assessing said best matching act-flow of said plurality of act-flows based on an interaction model associated with said best matching act-flow to result in an assessed act-flow of said plurality of assessed act-flows associated with an assessed interaction measure.

### BRIEF DESCRIPTION OF THE DRAWINGS

FIG. 1 provides a typical assessment of a university.

FIG. 1A provides a partial list of entities of a university.

FIG. 2 provides a typical list of student-related processes.

FIG. 2A provides a typical list of student locations.

FIG. 3 provides an illustrative detailing of sub-activities.

FIG. 3A provides a detailing of additional sub-activities.

FIG. 3B provides an overview of act-flow generation and assessment.

FIG. 3B-1 provides an overview of act-flow generation and assessment sub-systems.

FIG. 4 provides an illustrative act-flow related to the process Discussion.

FIG. 4A provides an illustrative act-flow related to the process Class.

FIG. 4B provides an illustrative act-flow related to the process Co-Study.

FIG. 4C provides an illustrative act-flow related to the process Library.

FIG. 4D provides an illustrative aspect measure of act-flow related to Discussion Process.

FIG. 4E provides an illustrative aspect measure of act-flow related to Class Process.

FIG. 4F provides an illustrative aspect measure of act-flow related to Co-Study Process.

FIG. 4G provides an illustrative aspect measure of act-flow related to Library Process.

FIG. 5 provides an overview of processing of Sub-Activities of a Student.

FIG. 5-1 provides the steps in the processing of sub-activities of a student.

FIG. 6 provides an approach for location correlation and consistency checking.

FIG. 6-1 provides the steps in the approach for location correlation and consistency checking.

FIG. 7 provides an approach for determining of an assessed instantiated act-flow.

FIG. 7-1 provides the steps in the approach for determining of an assessed instantiated act-flow.

FIG. 8 provides an approach for traversing of an act-flow.

FIG. 8-1 provides the steps in the approach for traversing of an act-flow.

FIG. 9 provides steps involved in selecting the best matching act-flow.

FIG. 9A provides an approach for selecting the best matching act-flow.

FIG. 9A-1 provides the steps in the approach for selecting the best matching act-flow.

FIG. 9B provides an approach for mode correlation and consistency checking.

FIG. 9B-1 provides the steps in the approach for mode correlation and consistency checking.

FIG. 10 provides an assessing of an instantiated act-flow.

FIG. 10-1 provides an assessing of an instantiated act-flow.

FIG. 11 provides an illustrative act-flow related to Journal paper submission.

FIG. 11A provides an illustrative aspect model based aspect measure of Journal Process.

FIG. 12 provides an approach for assessing of an instantiated act-flow based on Aspect Model.

FIG. 12-1 provides the steps in the approach for assessing of an instantiated act-flow based on Aspect Model.

FIG. 13 depicts an illustrative act-flow related to an interaction.

FIG. 14 provides an approach for assessing of an Instantiated act-flow based on an Interaction Model.

FIG. 14-1 provides the steps in the approach for assessing of an Instantiated act-flow based on an Interaction Model.

### DETAILED DESCRIPTION OF THE PREFERRED EMBODIMENTS

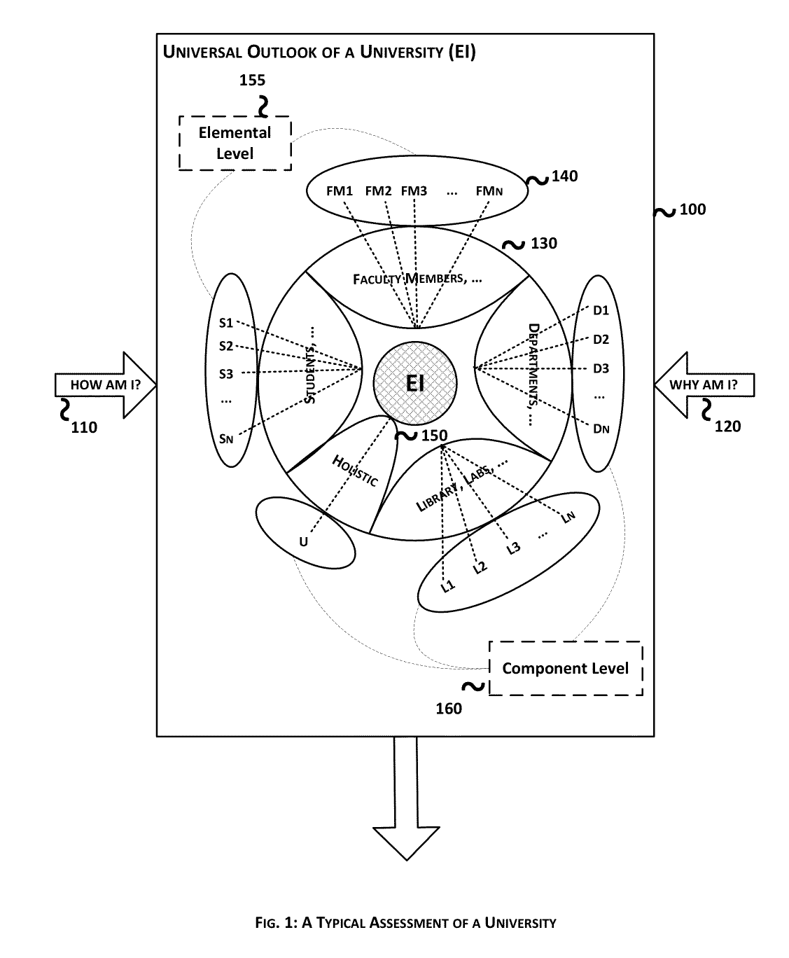

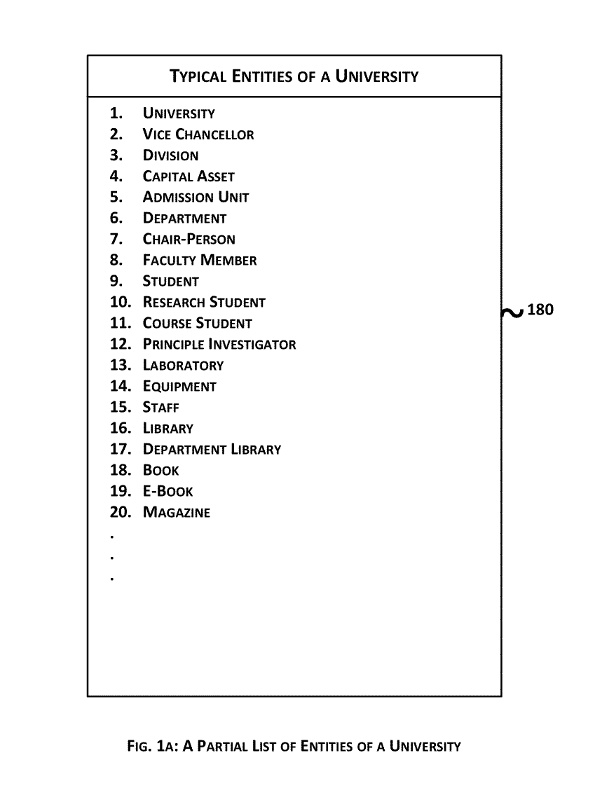

FIG. 1 provides a typical assessment of a university. An Educational Institution (E1) or alternatively, a university, is a complex and dynamic system with multiple entities and each interacting with multiple of other entities. The overall characterization of the E1 is based on a graph that depicts these multi-entities multiple relationships. An important utility of such a characterization is to assess the state and status of the E1. What it means is that, in the context of the E1, it is helpful if every of the entities of the E1 can be assessed. Assessment of the E1 as a whole and the constituents at an appropriate level gives an opportunity to answer the questions such as “How am I?” and “Why am I?”. That is, the assessment of each of the entities and an explanation of the same can be provided. Consider a STUDENT entity: This is one of the important entities of the E1 and in any E1 there are several instances of this entity that are associated with the students of the E1. The assessment can be at STUDENT level or at 51 (a particular student) level. 100 depicts the so-called “Universal Outlook of a University” and a system that provides such a universal outlook is capable of addressing “How am I?” (110) and “Why am I?” (120) queries. The FACULTY MEMBER entity (130) characterizes the set of all faculty members of FM1, FM2, FMn (140) of the E1. The holistic assessment (150) helps answer How and Why at university level. Observe that there are two distinct kinds of entities: One class of entities is at the so-called “Element” level (155)—this means that this kind of entities is at the atomic level as for as the university domain is concerned. On the other hand, there is a second class of entities at the so-called “Component” level (160) that accounts for remaining entities of the university domain all the way up to the University level. It is essential to determine the various act-flows associated with sub-activities of a student on the university campus in order to achieve a holistic assessment of STUDENT entity.

FIG. 1A depicts a partial list of entities of a university. Note that a deep domain analysis would uncover several more entities and also their relationship with the other entities (180). For example, RESEARCH STUDENT is a STUDENT who is a part of a DEPARTMENT and works with a FACULTY MEMBER in a LABORATORY using some EQUIPMENT, the DEPARTMENT LIBRARY, and the LIBRARY.

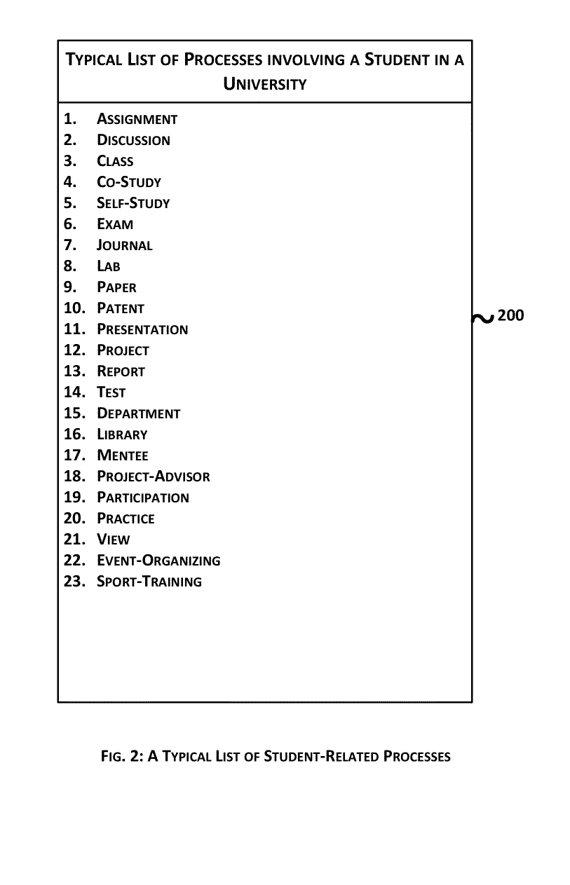

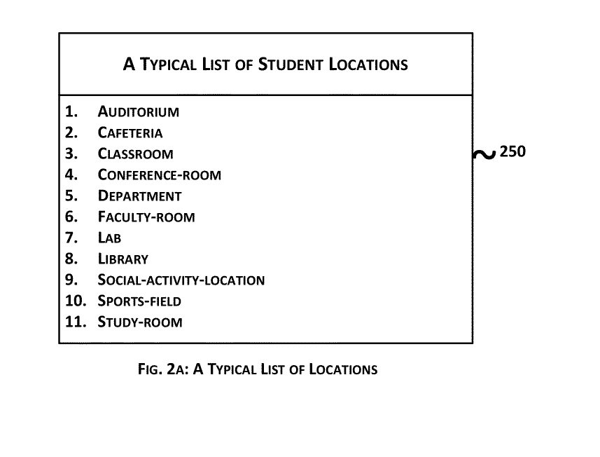

FIG. 2 provides a typical list of student-related processes. This list is arrived based on the deep domain analysis of a university and is from the point of view of STUDENT entity (200). Specifically, this list categorizes the various activities performed by a typical student within a university. Note that the holistic analysis of a student involves how these activities are performed by the student: for example, a typical behavior of the student in a classroom provides for certain characteristics of the student from the assessment point of view; similarly is the case of the student making a presentation.

FIG. 2A provides a list of typical student locations (250): (a) Auditorium; (b) Cafeteria; (c) Classroom; (d) Conference-room; (e) Department; (f) Faculty-room; (g) Lab; (h) Library; (i) Social-activity-location; (j) Sports-field; and (k) Study-room.

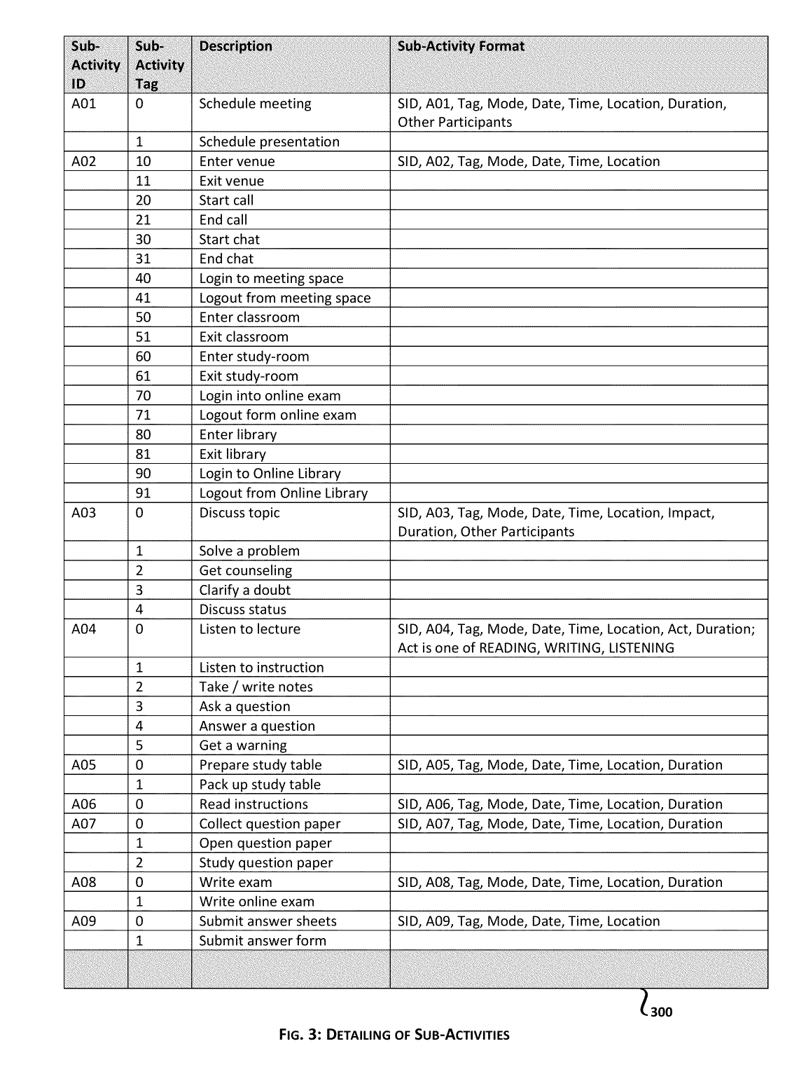

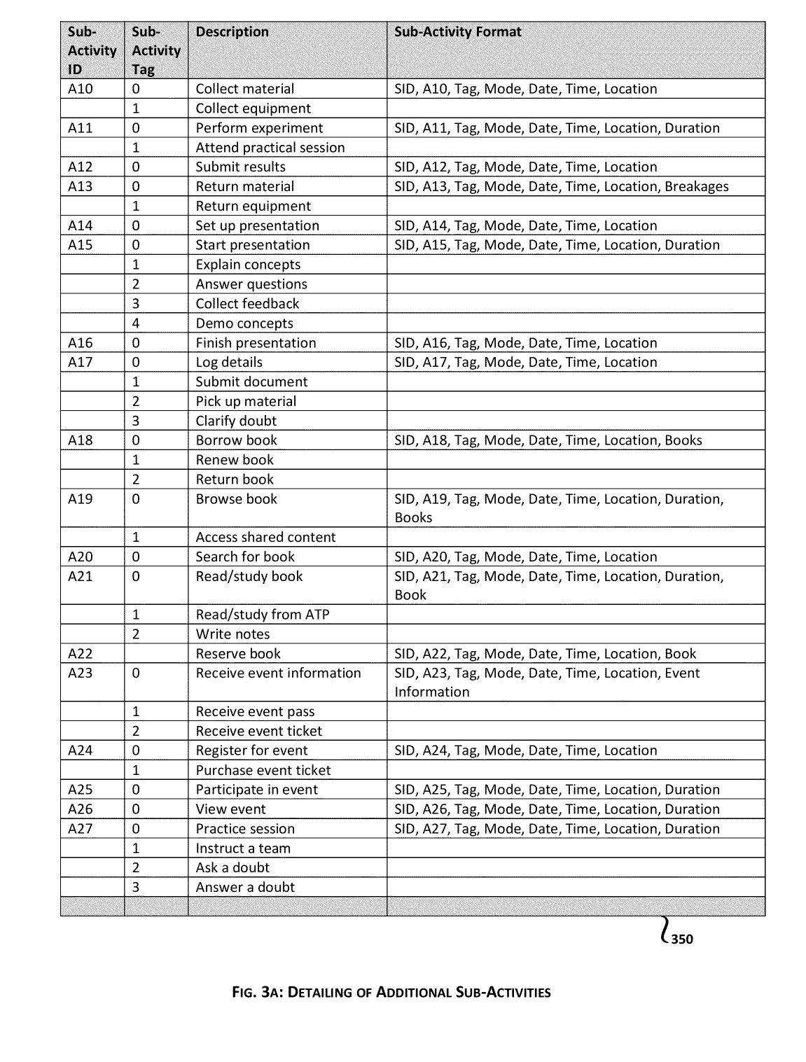

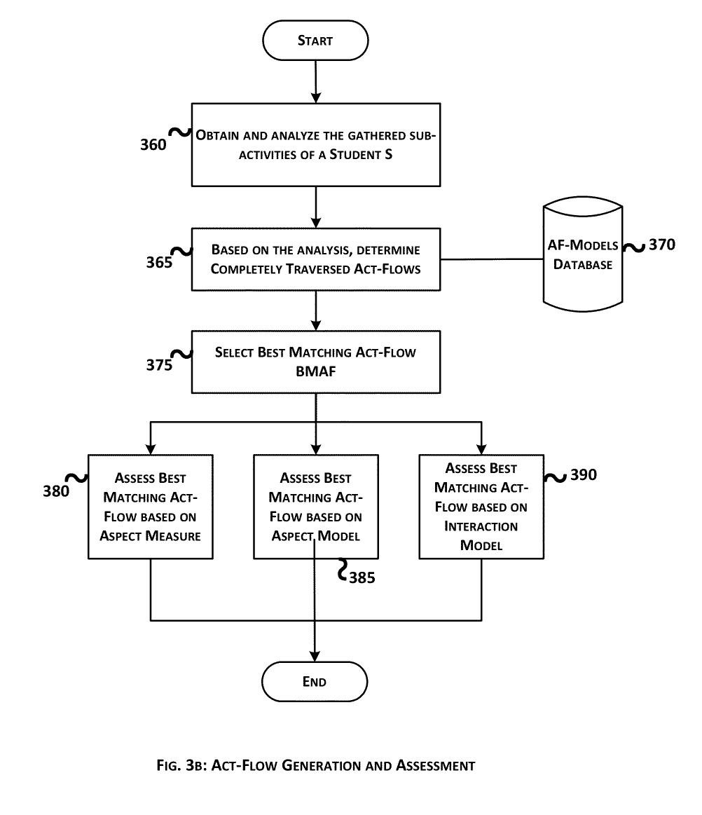

FIG. 3 provides an illustrative detailing of sub-activities of a student in a university context. A sub-activity as described in 300 is somewhat generic in nature and different kinds of actual realizations are distinguished based on sub-activity tags. For example, A02 is general entering or exiting a venue, the variation such as entering a library is indicated by A02(80) where 80 is the sub-activity tag value. The other important parameter of a sub-activity is mode: a sub-activity is related to a curricular set of activities, co-curricular set of activities, or an extra-curricular set of activities; and mode identifies in particular to which set (curricular set, co-curricular set, or extra-curricular set) does a particular sub-activity belong to. The parameter timestamp (TS) indicates the time of sub-activity and location stamp (LS) indicates the location of the sub-activity. As mentioned in FIG. 2, there are about eleven standard locations within and related to a university. Some of the sub-activities are provided below (300).

A01(0) Schedule meeting

A01(1) Schedule presentation

A02(10) Enter venue

A02(11) Exit venue

A02(20) Start call

A02(21) End call

A02(30) Start chat

A02(31) End chat

A02(40) Login to meeting space

A02(41) Logout from meeting space

A02(50) Enter classroom

A02(51) Exit classroom

A02(60) Enter study-room

A02(61) Exit study-room

A02(70) Login into online exam

A02(71) Logout form online exam

A02(80) Enter library

A02(81) Exit library

A02(90) Login to Online Library

A02(91) Logout from Online Library

A03(0) Discuss topic

A03(1) Solve a problem

A03(2) Get counseling

A03(3) Clarify a doubt

A03(4) Discuss status

A04(0) Listen to lecture

A04(1) Listen to instruction

A04(2) Take/write notes

A04(3) Ask a question

A04(4) Answer a question

A04(5) Get a warning

A05(0) Prepare study table

A05(1) Pack up study table

A06(0) Read instructions

A07(0) Collect question paper

A07(1) Open question paper

A07(2) Study question paper

A08(0) Write exam

A08(1) Write online exam

A09(0) Submit answer sheets

A09(1) Submit answer form

FIG. 3A provides details of additional sub-activities. Some of the additional sub-activities (350) are provided below.

A10(0) Collect material

A10(1) Collect equipment

A11(0) Perform experiment

A11(1) Attend practical session

A12(0) Submit results

A13(0) Return material

A13(1) Return equipment

A14(0) Set up presentation

A15(0) Start presentation

A15(1) Explain concepts

A15(2) Answer questions

A15(3) Collect feedback

A15(4) Demo concepts

A16(0) Finish presentation

A17(0) Log details

A17(1) Submit document

A17(2) Pick up material

A17(3) Clarify doubt

A18(0) Borrow book

A18(1) Renew book

A18(2) Return book

A19(0) Browse book

A19(1) Access shared content

A20(0) Search for book

A21(0) Read/study book

A21(1) Read/study from ATP

A21(2) Write notes

A22(0) Reserve book

A23(0) Receive event information

A23(1) Receive event pass

A23(2) Receive event ticket

A24(0) Register for event

A24(1) Purchase event ticket

A25(0) Participate in event

A26(0) View event

A27(0) Practice session

A27(1) Instruct a team

A27(2) Ask a doubt

A27(3) Answer a doubt

FIG. 3B provides an overview of act-flow generation and assessment.

The first step is to gather all the related sub-activities of a student S of a university (360). All of these gathered sub-activities are analyzed and based on the analysis, the act-flows are identified (365).

An act-flow is a depiction of activity flow and comprises of the sub-activities, wherein the act-flow is an instantiated version of an act-flow model. As part of the domain analysis, a set of act-flow (AF) models are identified and are a part of AF-Models Database (370). An act-flow model is a collection of nodes and directed edges that connect the nodes; a node denotes a particular state of a student and a directed edge stands for a sub-activity. The sub-activity is associated with a set of parameters called act-params and a measure associated with a sub-activity is called as act-measure that is based on a pre-defined function with the set of act-params. A measure associated with an act-flow is called as aspect-measure and is a value between 0 and 1.

An aspect model is an alternative way to assess a collection of sub-activities. In particular, an aspect model is based on a set of sub-aspects with each sub-aspect being associated with a set of sub-aspect parameters called sa-params; a sub-aspect along with sa-params is a measure of certain portion of the student's activities. A sub-aspect measure is called sa-measure and is based on a pre-defined function along with sa-params. An aspect-model is defined as a function based on a set of sa-measures. The aspect-measure based on the aspect model is a value between 0 and 1.

The student interactions on the University campus form part of another factor of the holistic assessment of a student in a University. The interactions, say, between students, and between a faculty member and a student, have an impact on molding a student, as the interactions over a period of time results in influencing the student towards achieving their goal. Specifically, the influences could be positive, neutral, or negative, and the University aspires to build an environment that can positively influence the students and help achieve their goals in an effortless manner.

An interaction is defined to be among a set of actors (say, students and faculty members) and actors exert influence upon each other. An actor can influence another actor either positively or negatively; or alternatively, the actor may not influence at all the another actor. The nature of an influence is positive, neutral, or negative; and the quantum of influence is a value between −1 and +1. The influence value is based on the (a) source S of the influence; (b) receiver R of the influence; (c) behavior measure BM; (d) reaction measure RM; (e) impact from the source IS; and (f) impact at the receiver IR. Both BM and RM are measured based on gesture and emotion indicators. The interactions are described using sequence diagrams. A particular interaction involves a collection of sub-interactions. Several of the communications part of a sub-interaction finally results in an impact leading to an influencing factor (also called as influence value). This step involves the usage of a pre-defined database (370) of act-flow models.

As the next step, given a collection of act-flows depicting a set of sub-activities, the best matching act-flow (BMAF) is selected (375). The selected BMAF is assessed based on an aspect measure (380), based on an aspect model (385 and 385-1), or based on an interaction model (390).

FIG. 3B-1 shows in block diagram from the sub-system comprising various means represented by reference numerals 365-1, 375-1, 380-1, 385-1, and 390-1 for carrying out the steps 365, 375, 380, 385, and 390 of FIG. 3B.

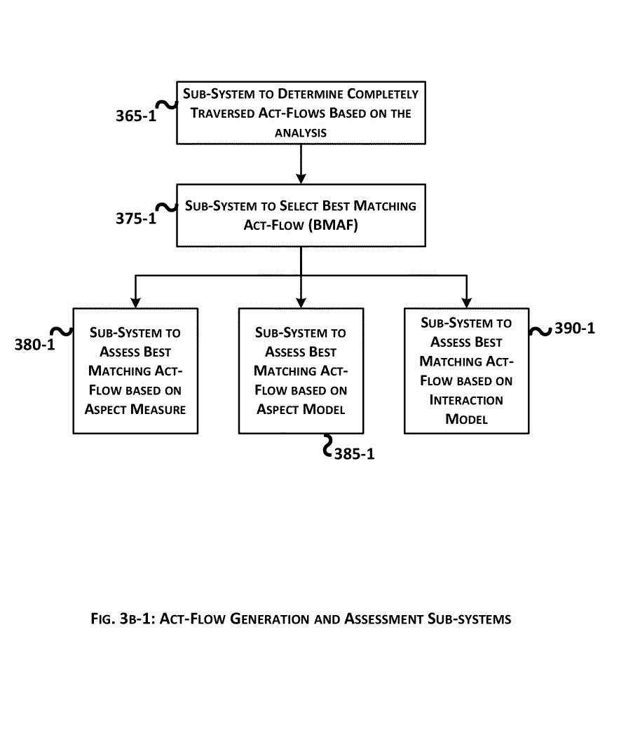

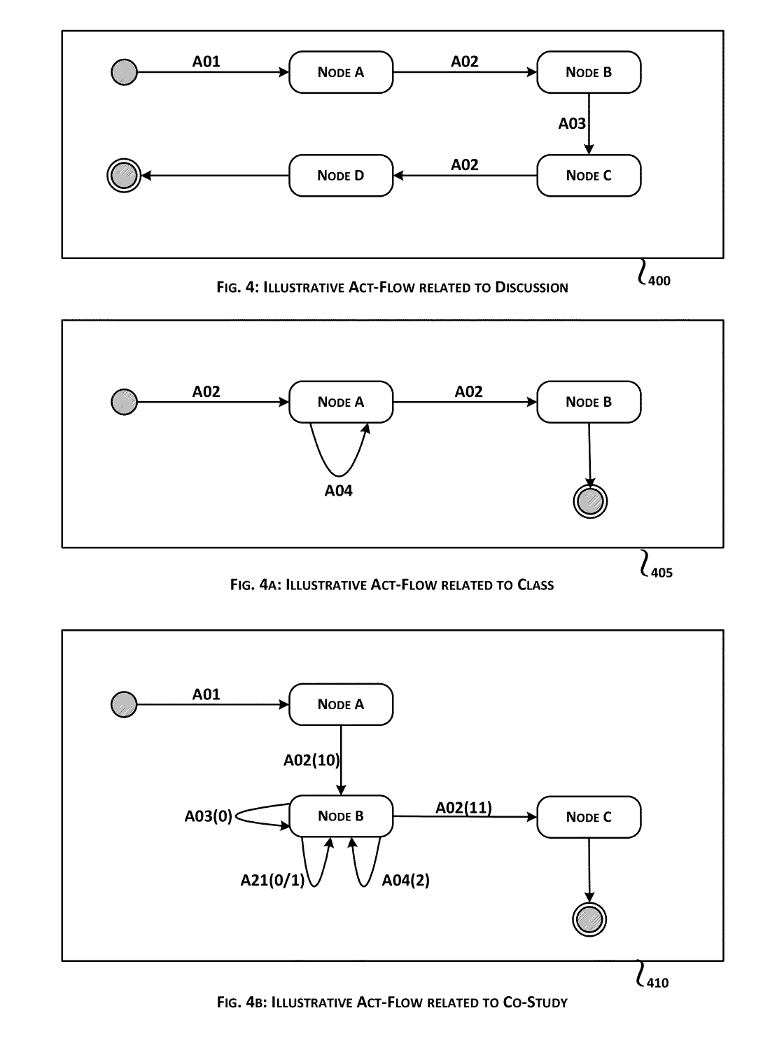

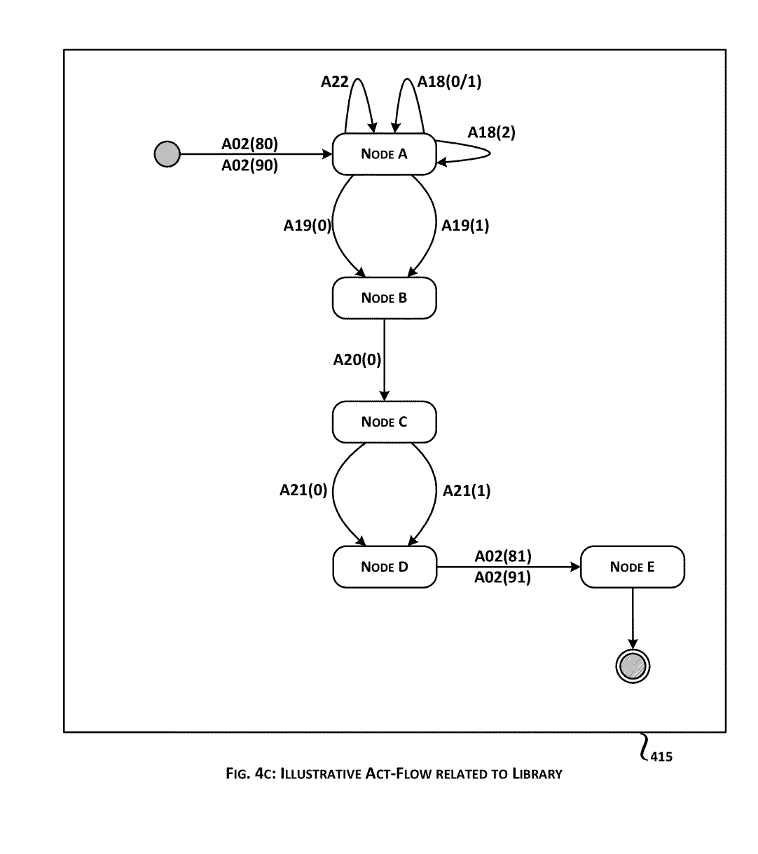

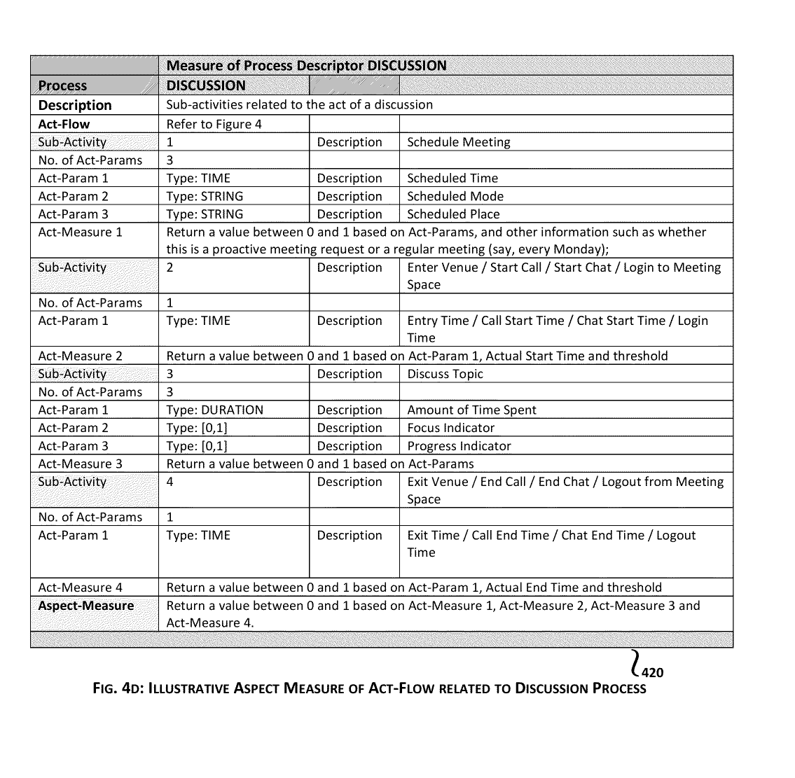

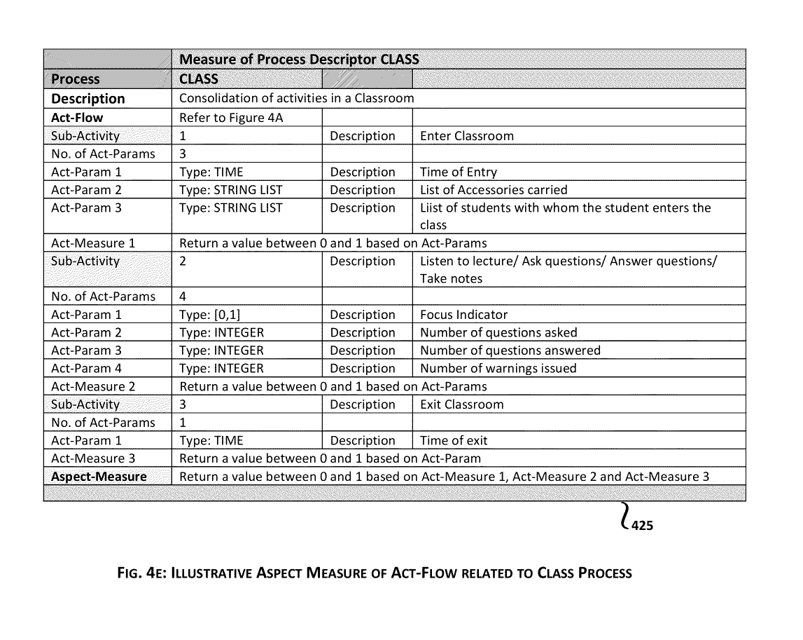

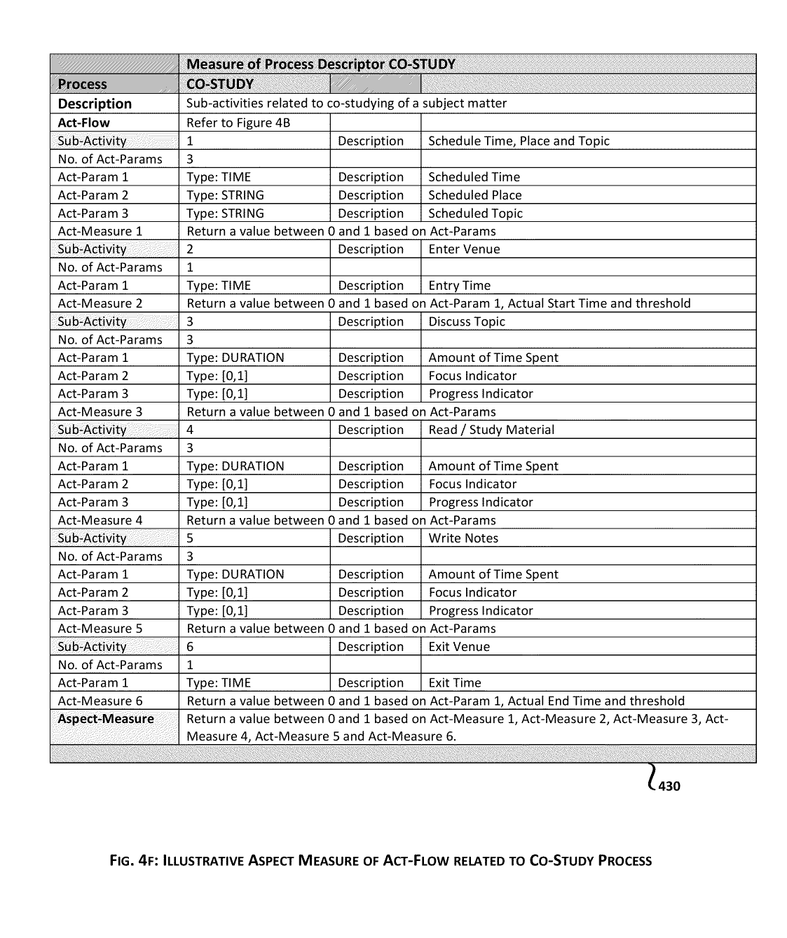

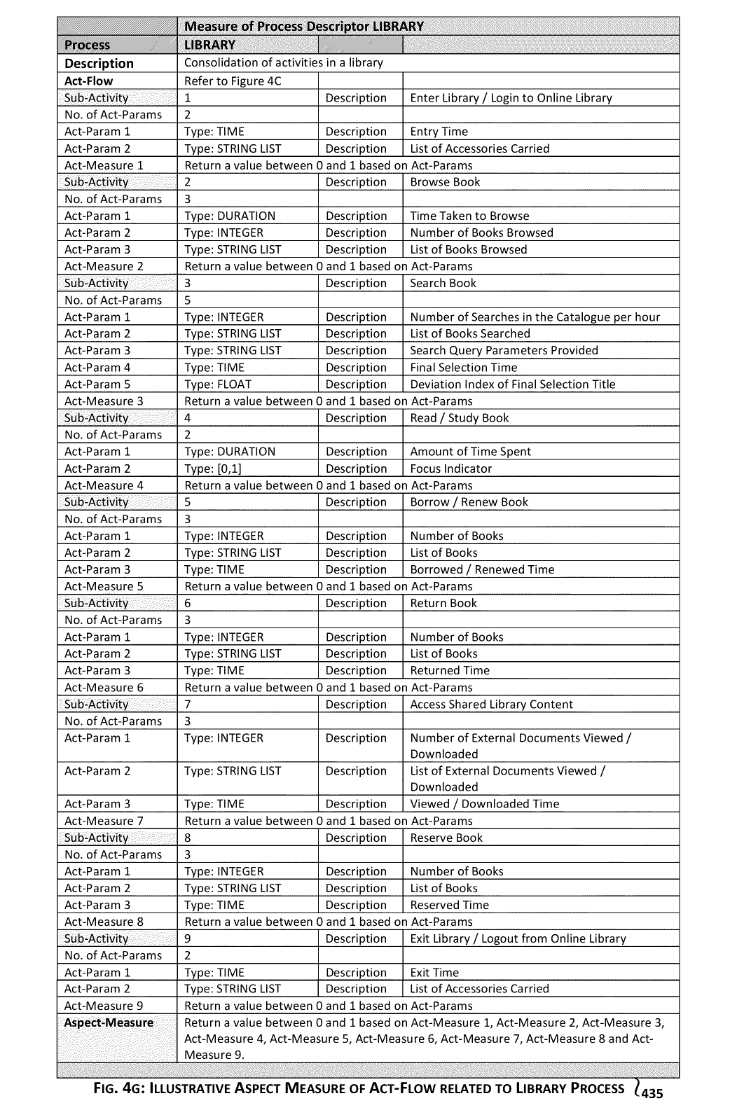

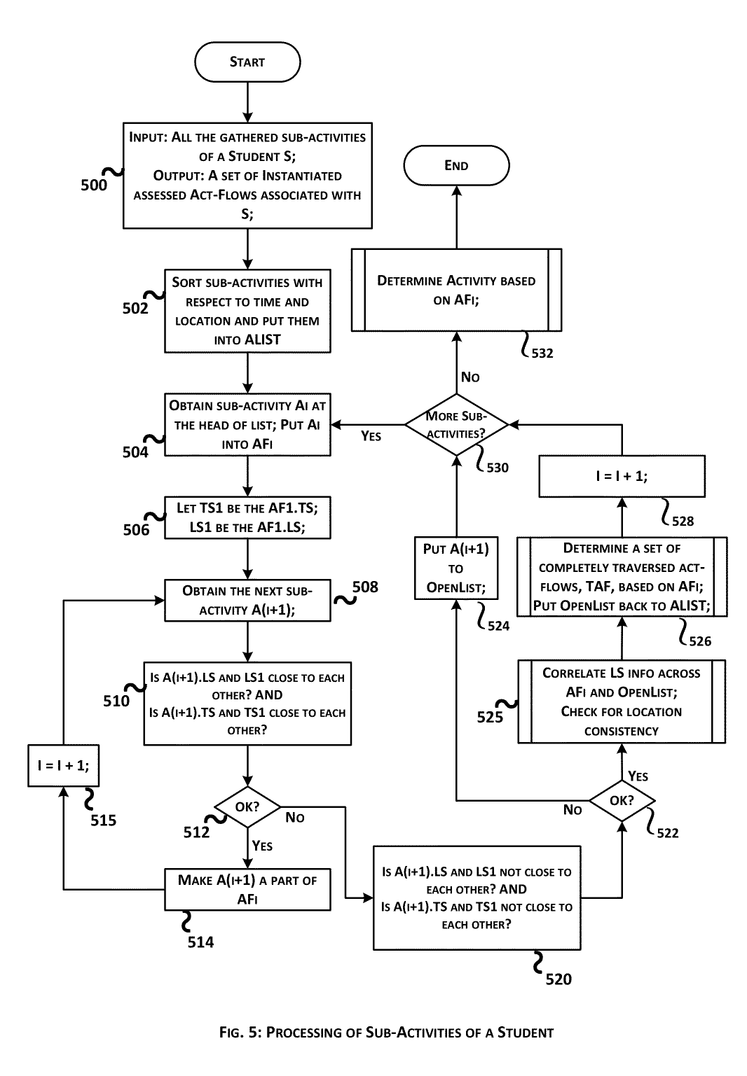

FIG. 4 provides an illustrative act-flow related to the process Discussion. 400 elaborates on the act-flow with sub-activities A01 (Schedule meeting), A02 (Enter venue), A03 (Discuss topic), and A02 (Exit venue).

FIG. 4A provides an illustrative act-flow related to the process Class. 405 elaborates on the act-flow with sub-activities A02, A04 (Listen to lecture), and A02.

FIG. 4B provides an illustrative act-flow related to the process Co-Study. 410 elaborates on the act-flow with sub-activities A01, A02(10) (Enter venue), A03(0) (Discuss topic), A21(0/1) (Read/study), A04(2) (Listen to instruction), and A02(11) (Exit venue).

FIG. 4C provides an illustrative act-flow related to the process Library. 415 elaborates on the sub-activities related to a student during a visit to a library. Typical sub-activities include A02(80/90) (Enter library/Login to Online Library), A22 (Reserve book), A18(0/1/2) (Borrow book/Renew book/Return book), A19(0/1) (Browse book/Access shared content), A20(0) (Search for book), A21(0/1) (Read/study book/Read/study from Any Tablet Phone(ATP)), A02(81/91) (Exit library/Logout from Online Library).

FIG. 4D provides an illustrative aspect measure of act-flow related to Discussion Process. 420 describes act-measure along with act-params associated with each of the four sub-activities (Act-Measure 1 through Act-Measure 4), and Aspect-Measure as a function based on these four act-measures.

FIG. 4E provides an illustrative aspect measure of act-flow related to Class Process. 425 descirbes the aspect measure based on three act-measures associated with the three sub-activities.

FIG. 4F provides an illustrative aspect measure of act-flow related to Co-Study Process. 430 describes the aspect measure based on six act-measures associated with the six sub-activities.

FIG. 4G provides an illustrative aspect measure of act-flow related to Library Process. 435 describes the aspect measure based on nine act-measures associated with the nine sub-activities.

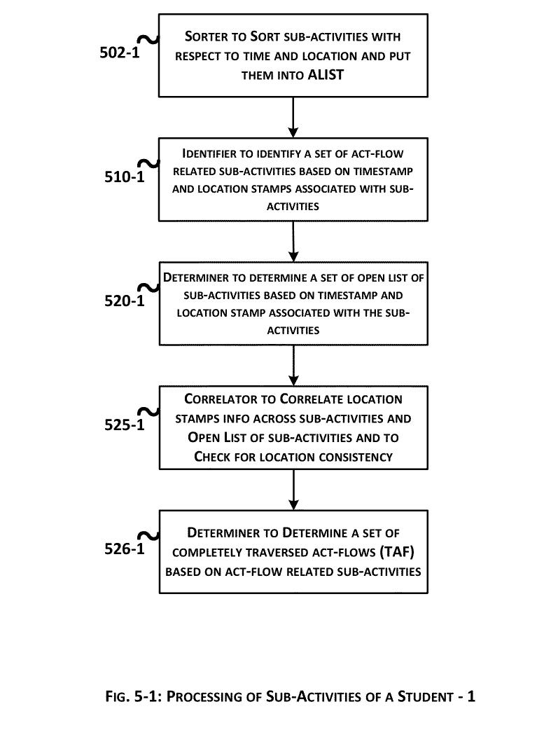

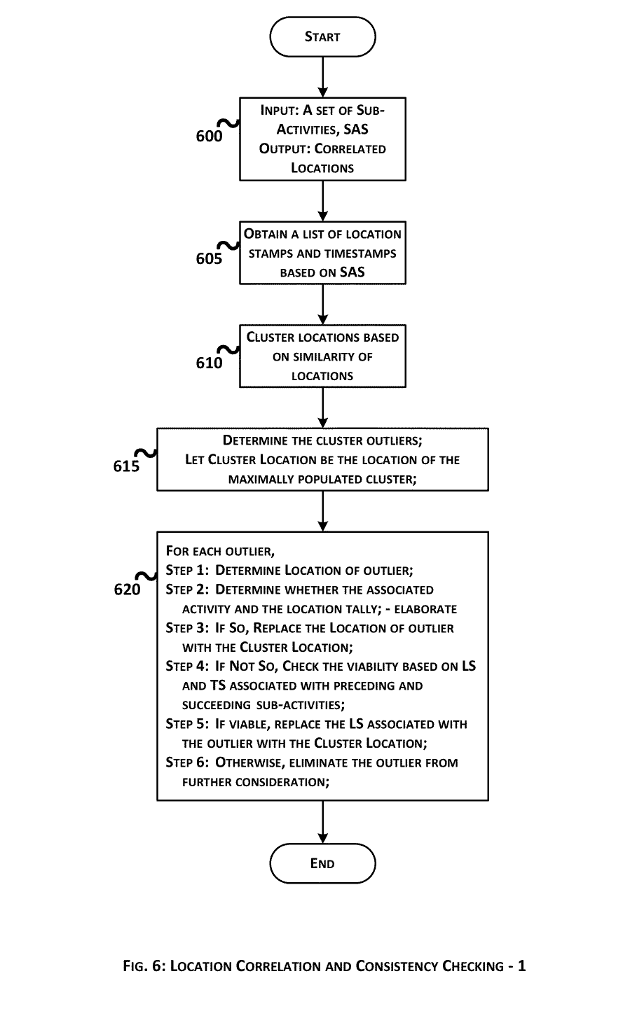

FIG. 5 provides an overview of processing of Sub-Activities of a Student. The gathered sub-activities of a student form the input and output is the set of instantiated assessed act-flows. Sort sub-activities with respect to time and location, and put them into ALIST. Note that each of the sub-activities is associated with a timestamp (TS) and a location stamp (LS) (502). Our objective is to process together those sub-activities that occur around the same time (sub-activity dependent) and at the same location. Obtain sub-activity Ai at the head of list; Put Ai into AFi (504). Let TS1 be the timestamp associated with Ai (that is, AF1.TS); and let LS1 be the location stamp associated with Ai (that is, AF1.LS) (506). Obtain the next sub-activity A(i+1) (508). Is A(i+1).LS and LS1 close to each other? AND Is A(i+1).TS and TS1 close to each other? (510). If so (512), make A(i+1) a part of AFi (514), increment so as to obtain the next sub-activity (515). If it is not so (512), is A(i+1).LS and LS1 not close to each other? And is A(i+1).TS and TS1 not close to each other? (520) If not so (522), A(i+1) may be an outlier with respect to AFi and hence, put A(i+1) to OpenList (524) and proceed to process more sub-activities if they are available (530). If it is so (522), correlate LS info across AFi and OpenList and check for location consistency (525). Determine the set of completely traversed act-flows, TAF, based on AFi; that is, temporally and spatially related sub-activities are analyzed to determine if they denote an activity (526). Put OpenList back to ALIST. Proceed to process the remaining sub-activities (528). If no more sub-activities are available (530), determine Activity based on AFi (532).

FIG. 5-1 shows in block diagram from the sub-system comprising various means represented by reference numerals 502-1, 510-1, 520-1, 525-1, and 526-1 for carrying out the steps 502, 510, 520, 525, and 526 of FIG. 5.

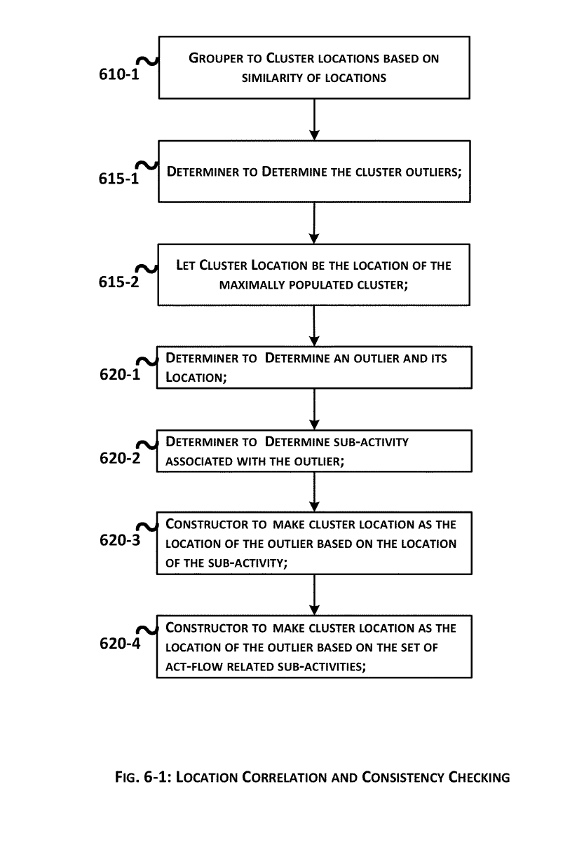

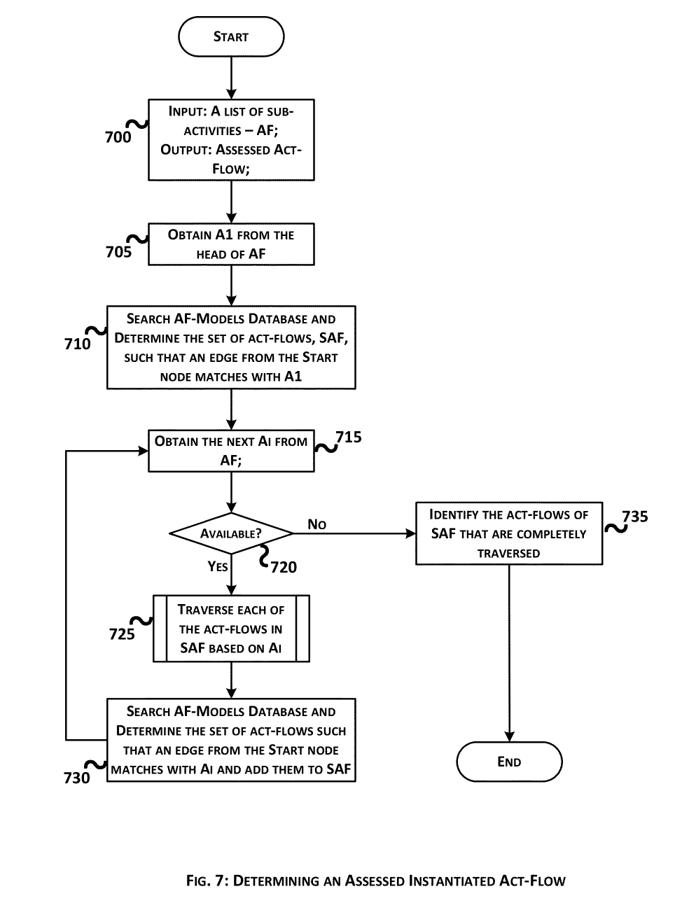

FIG. 6 provides an approach for location correlation and consistency checking. A set of Sub-Activities, SAS forms the input (600) and the output is the correlated locations of the sub-activities of SAS. Obtain a list of location stamps and timestamps based on SAS (605). Cluster locations based on similarity of locations (610). Determine the cluster outliers; Let Cluster Location be the location of the maximally populated cluster (615). For each outlier, perform the following (620):

Step 1: Determine Location of outlier;

Step 2: Determine whether the associated activity and the location tally; this step is based on the fact that each of the sub-activities of a student occurs in one of the pre-defined eleven locations, and more particularly, the sub-activities are expected to happen in one or more of the particular locations. For example, the location of the sub-activity “Borrow/return book” is expected to be “Library.”

Step 3: If So, Replace the Location of outlier with the Cluster Location;

Step 4: If Not So, Check the viability based on LS and TS associated with preceding and succeeding sub-activities;

Step 5: If viable, replace the Location associated with the outlier with the Cluster Location;

Step 6: Otherwise, eliminate the outlier from further consideration.

The above steps help to correlate locations across a set of sub-activities leading to the elimination of location inconsistency.

FIG. 6-1 shows in block diagram from the sub-system comprising various means represented by reference numerals 610-1, 615-1, 615-2, 620-1, 620-2, 620-3, and 620-4 for carrying out the steps 610, 615, and 620 of FIG. 6.

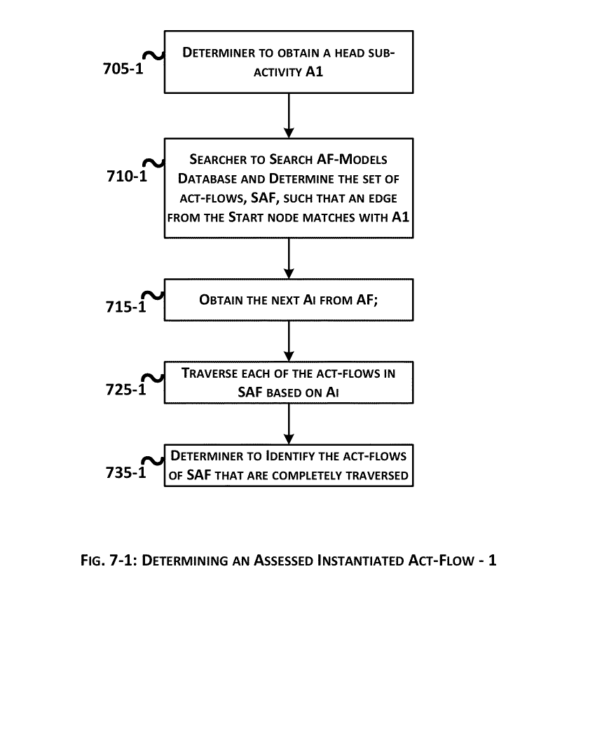

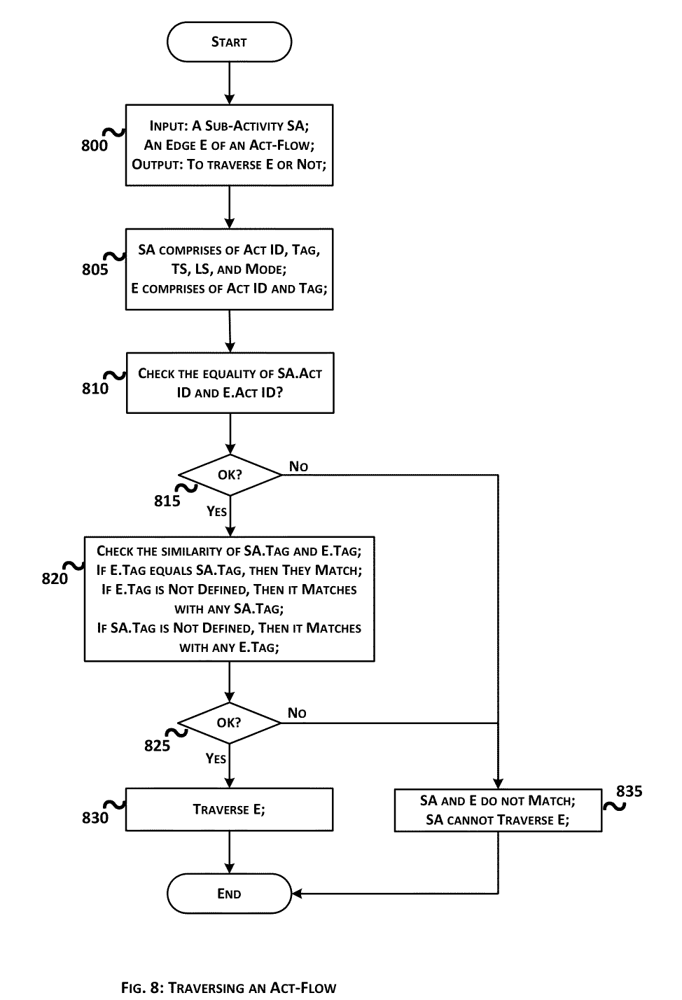

FIG. 7 provides an approach for determining of an assessed instantiated act-flow. A list of sub-activities AF, form the input and an assessed instantiated act-flow is the output of this approach (700). Obtain sub-activity Al from the head of AF (705). Search AF-Models Database and determine the set of act-flows, SAF, such that an edge from the Start node of each of these act-flows matches with Al (710 Obtain the next Ai from AF (715). If it is available (720), traverse each of the act-flows in SAF based on Ai (725). Search AF-Models Database and determine the set of act-flows such that an edge from the Start node matches with Ai and add them to SAF (730). Proceed to process the next Ai from AF. If not so (720), identify act-flows of SAF that are completely traversed—TAF (735).

FIG. 7-1 shows in block diagram from the sub-system comprising various means represented by reference numerals 705-1, 710-1, 715-1, 725-1, and 735-1 for carrying out the steps 705, 710, 715, 725, and 735 of FIG. 7.

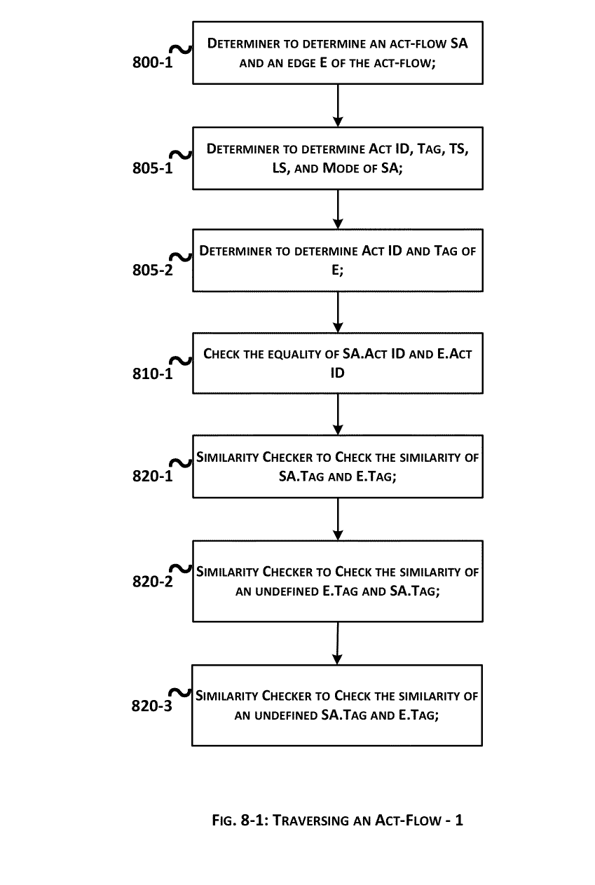

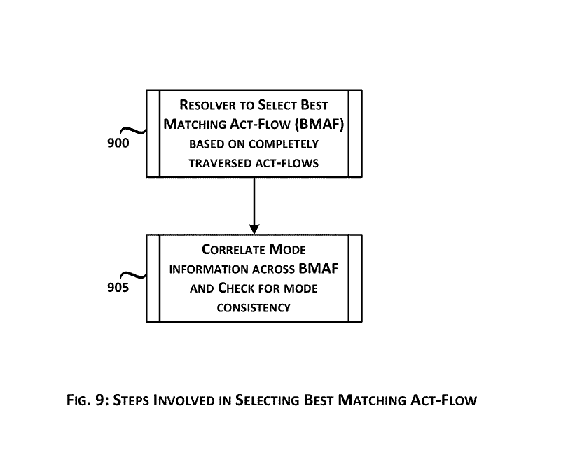

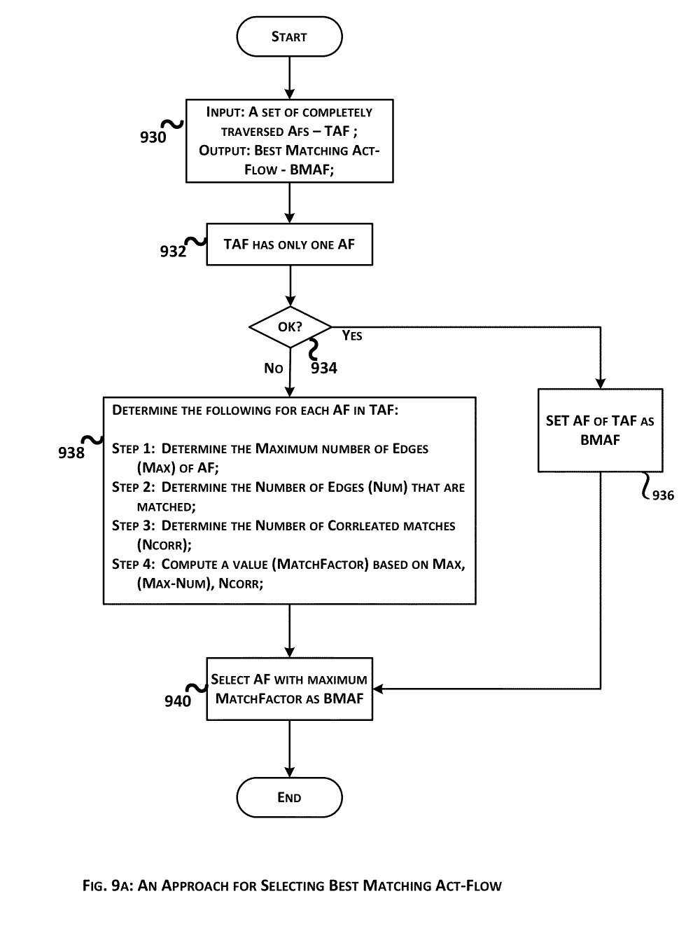

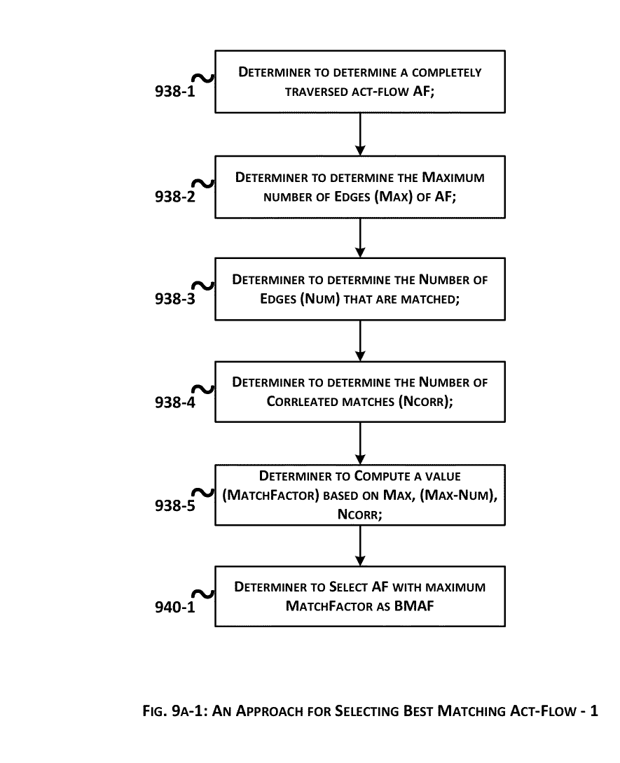

FIG. 8 provides an approach for traversing of an act-flow. A Sub-Activity SA and an edge E of an act-flow form the input and it is required to determine whether E can be traversed or not (800). SA comprises of Act ID, Tag, TS, LS, and Mode; and E comprises of Act ID and Tag (805). Check the equality of SA.Act ID and E.Act ID (810). That is, determine that sub-activities match. If so (815), Check the similarity of SA.Tag and E.Tag (820); If E.Tag equals SA.Tag, then they match; if E.Tag is not defined, then it matches with any SA.Tag; and if SA.Tag is not defined, then it matches with any E.Tag. If so (825), traverse E (830). If not so (825), SA and E do not match; and hence, SA cannot Traverse E (835).

FIG. 8-1 shows in block diagram from the sub-system comprising various means represented by reference numerals 800-1, 805-1, 805-2, 810-1, 820-1, 820-2, and 820-3 for carrying out the steps 800, 805, 810, and 820 of FIG. 8.

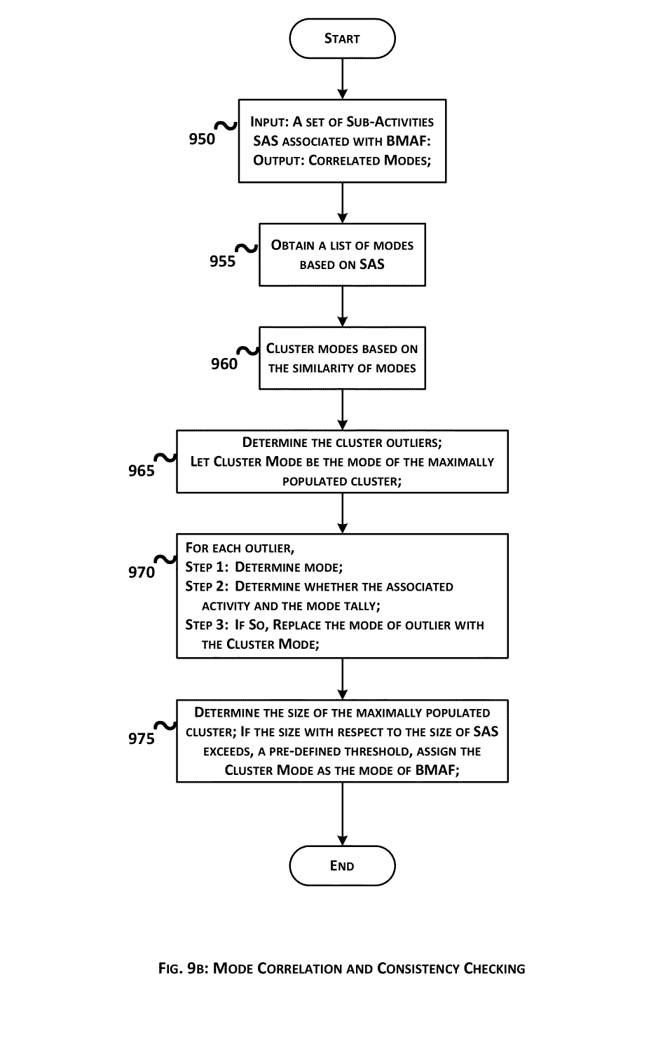

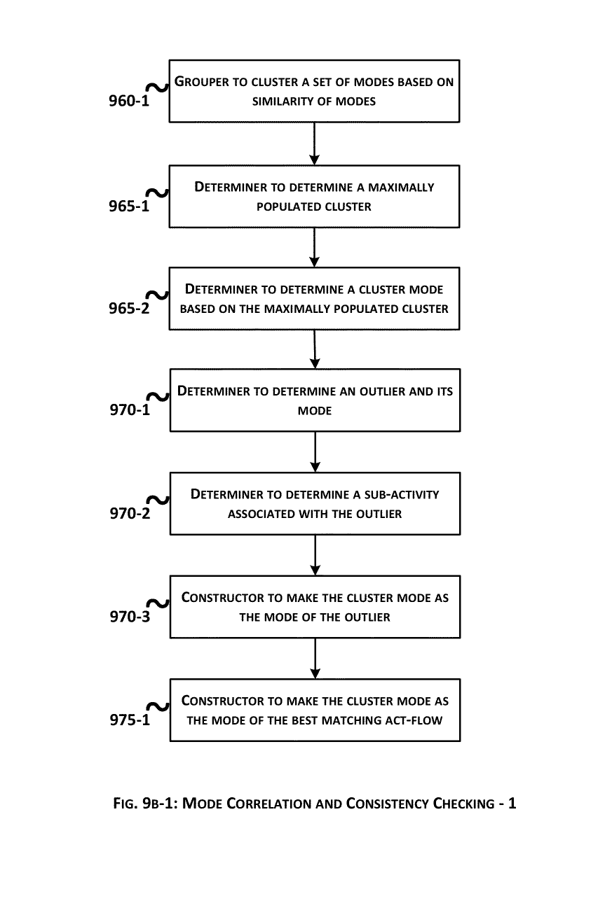

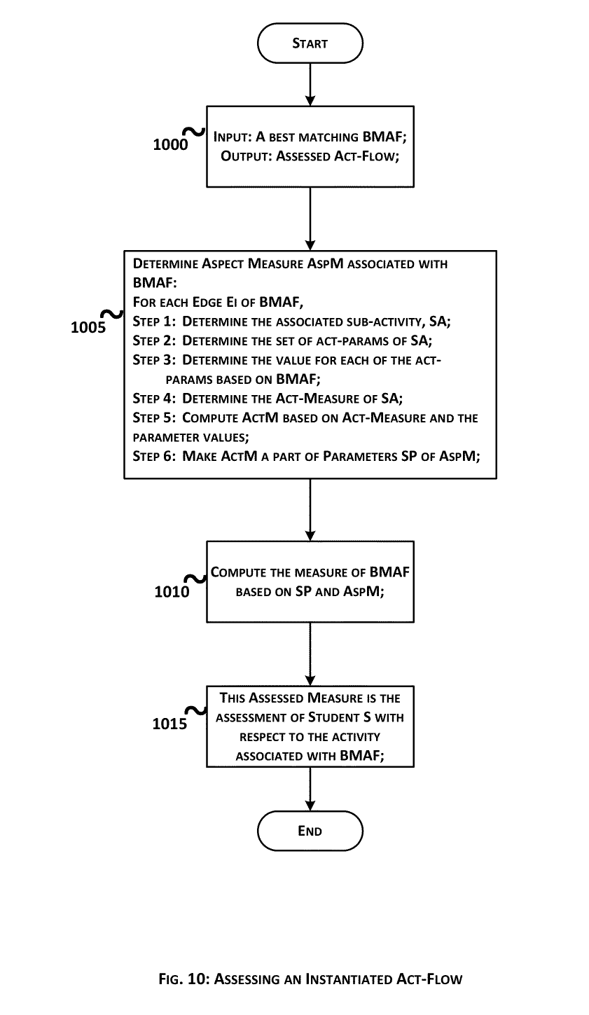

FIG. 9 provides steps involved in selecting the best matching act-flow.

The first step (905) is to select Best Matching Act-Flow (BMAF) based on completely traversed act-flows. And the next step (910) is to correlate mode information across BMAF and to check for mode consistency.

FIG. 9A provides an approach for selecting the best matching act-flow. A set of completely traversed act-flows, TAF forms the input and the Best Matching Act-Flow among TAF is the output (930). Check whether TAF has only one AF (932). If so (934), set TAF as BMAF (best matched act-flow) (936). Else (934), resolve and select the BMAF from TAF (938). This resolving involves identifying an act-flow with the maximum number of nodes and edges, and minimum number of outliers. The input is a set of completely traversed act-flows, TAF and the output is the Best Matching Act-Flow—BMAF.

For each AF in TAF, perform the following steps (938):

Step 1: Determine the Maximum number of Edges (Max) of AF;

Step 2: Determine the Number of Edges (Num) that are matched;

Step 3: Determine the Number of Corrleated matches (Ncorr); This determines the amount of corrections applied on an act-flow.

Step 4: Compute a value (MatchFactor) based on Max, (Max-Num), Ncorr;

Select AF with maximum MatchFactor as BMAF (940).

FIG. 9A-1 shows in block diagram from the sub-system comprising various means represented by reference numerals 938-1, 938-2, 938-3, 938-4, 938-5, and 940-1 for carrying out the steps 938 and 940 of FIG. 9A.

FIG. 9B provides an approach for mode correlation and consistency checking. A set of sub-activities SAS associated with BMAF forms the input and correlated modes of the sub-activities of BMAF form the output (950). Obtain a list of modes based on SAS (955). Cluster modes based on the similarity of modes (960). Determine the cluster outliers; and let Cluster Mode be the mode of the maximally populated cluster (965). For each outlier perform the following steps (970):

Step 1: Determine mode;

Step 2: Determine whether the associated activity and the mode tally;

Step 3: If so, replace the mode of outlier with the Cluster Mode.

Determine the size of the maximally populated cluster; if the size with respect to the size of SAS exceeds a pre-defined threshold, assign the Cluster Mode as the mode of BMAF (975).

The mode indicates whether a particular sub-activity is related to curricular-, co-curricular-, or extra-curricular-set of activities, and hence, it is expected that the mode values across the sub-activities remain consistent.

FIG. 9B-1 shows in block diagram from the sub-system comprising various means represented by reference numerals 960-1, 965-1, 965-2, 970-1, 970-2, 970-3, and 975-1 for carrying out the steps 960, 965, 970, and 975 of FIG. 9B.

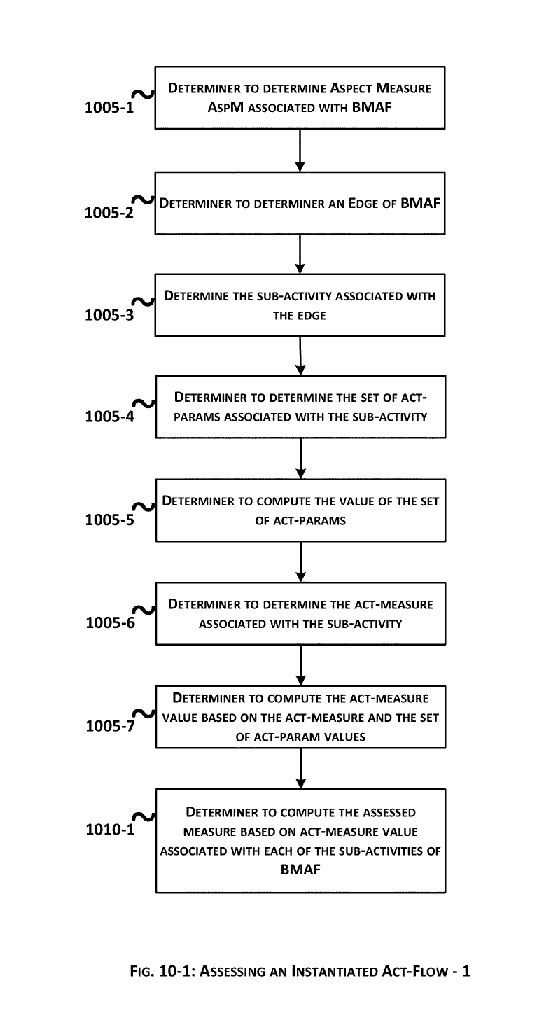

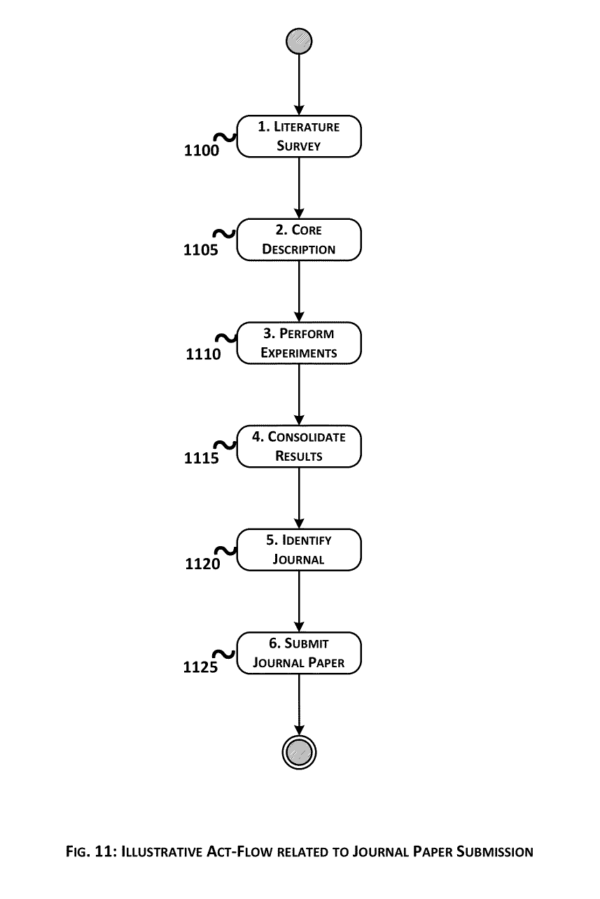

FIG. 10 provides an assessing of an instantiated act-flow. A best matching act-flow, BMAF forms the input and the assessment value of the act-flow forms the output (1000). Determine Aspect Measure AspM associated with BMAF (1005).

For each Edge Ei of BMAF perform the following steps (1005):

Step 1: Determine the associated sub-activity, SA;

Step 2: Determine the set of act-params of SA;

Step 3: Determine the value for each of the act-params based on BMAF;

Step 4: Determine the Act-Measure of SA;

Step 5: Compute ActM based on Act-Measure and the parameter values;

Step 6: Make ActM a part of Parameters SP of AspM.

Compute the measure of BMAF based on SP and AspM (1010).

This measure is the assessment of Student S with respect to the activity associated with BMAF (1015).

FIG. 10-1 shows in block diagram from the sub-system comprising various means represented by reference numerals 1005-1, 1005-2, 1005-3, 1005-4, 1005-5, 1005-6, 1005-7, and 1010-1 for carrying out the steps 1005 and 1010 of FIG. 10.

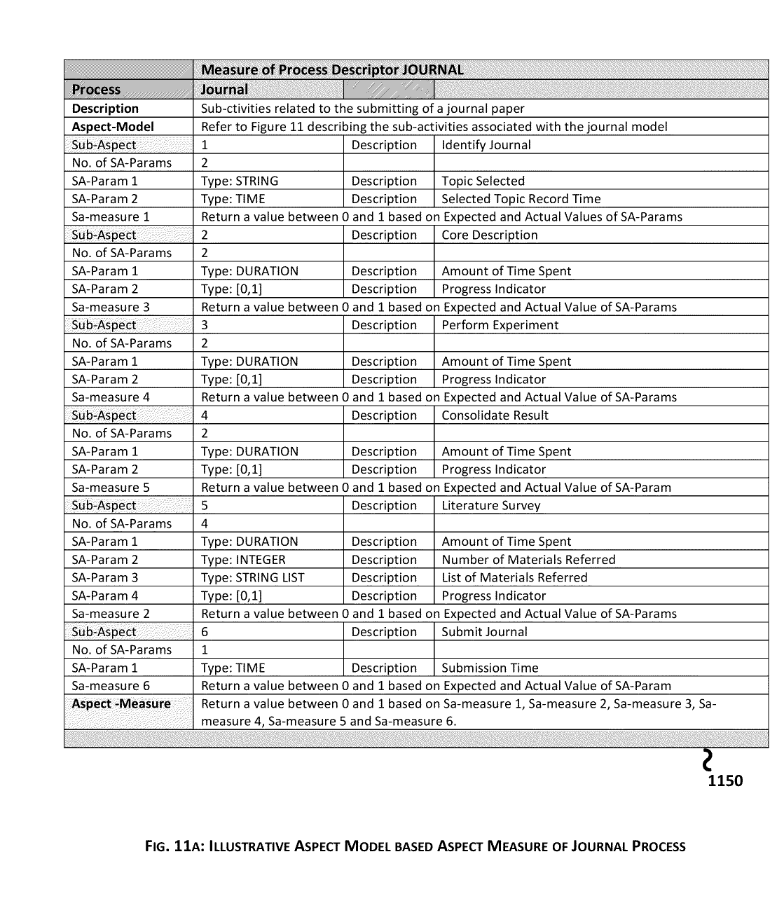

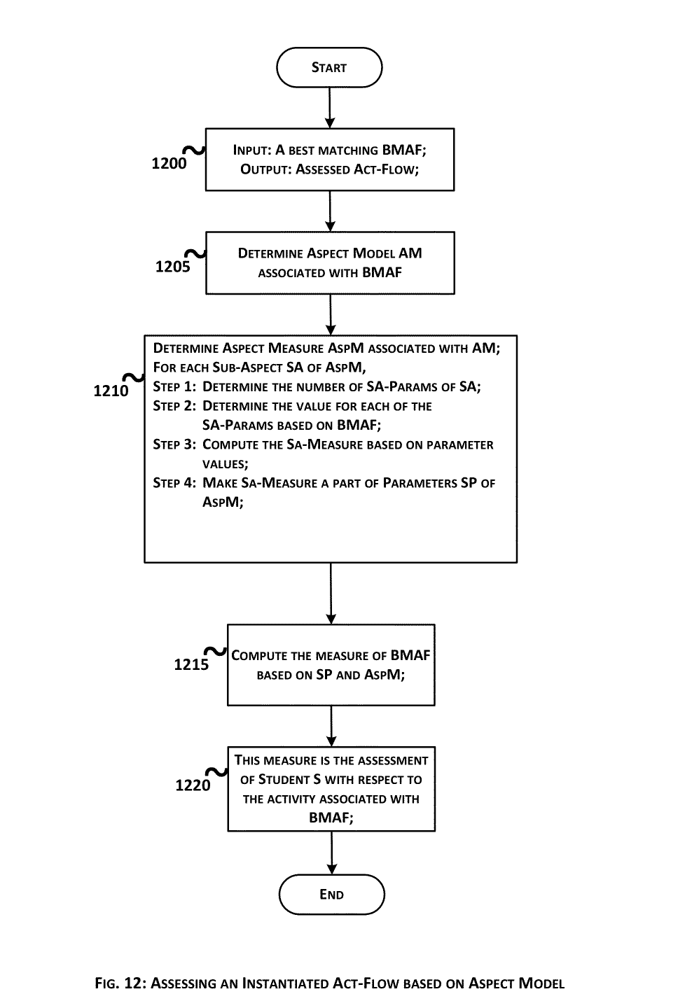

FIG. 11 provides an illustrative act-flow related to Journal paper submission. The duration of the sub-activities considered until now are relatively short. On the other hand, comparatively, the duration of the sub-activities depicted in this figure is longer. Keeping in mind this important distinction, the assessment of these kinds of act-flows is based on the notion of an aspect-model. Some of the key sub-activities are provided below:

Sub-Activity 1: Literature suvery (1100)—is related to the technical literature study and reporting undertaken by the student.

Sub-Activity 2: Core description (1105)—is related to the elaborating of the solution to solve the chosen technical problem.

Sub-Activity 3: Perform Experiments (1110)—is related to the conducting of experiments in order to ensure the proposed solution indeed solves the chosen technical problem.

Sub-Activity 4: Consolidate Results (1115)—is related to generating of results to ensure that the experiments are repeatable.

Sub-Activity 5. Identify Journal (1120)—is related to the identification of the journals that are appropriate for the research work being pursued;

Sub-Activity 6. Submit Journal Paper (1125)—is related to the act of preparing of the manuscript and submitting of the same to the chosen journal.

Observe that the above sub-activities could take quite some time to complete and hence, these sub-activities are dealt in a different manner as compared with the previously described act-flows.

FIG. 11A provides an illustrative aspect model based aspect measure of Journal Process. 1150 elaborates various sub-aspects, their parameters, and the aspect measure. There are six sub-aspects each with a pre-defined number of sub-aspect parameters (Sa-Params). Each sub-aspect is also associated with a sub-aspect measure (Sa-measure) that is a pre-defined function based on the associated set of Sa-Params and returns a value between 0 and 1. Finally, Aspect Measure is a pre-defined function that operates on Sa-measures (Sa-measure 1 through Sa-measure 6) to return value between 0 and 1.

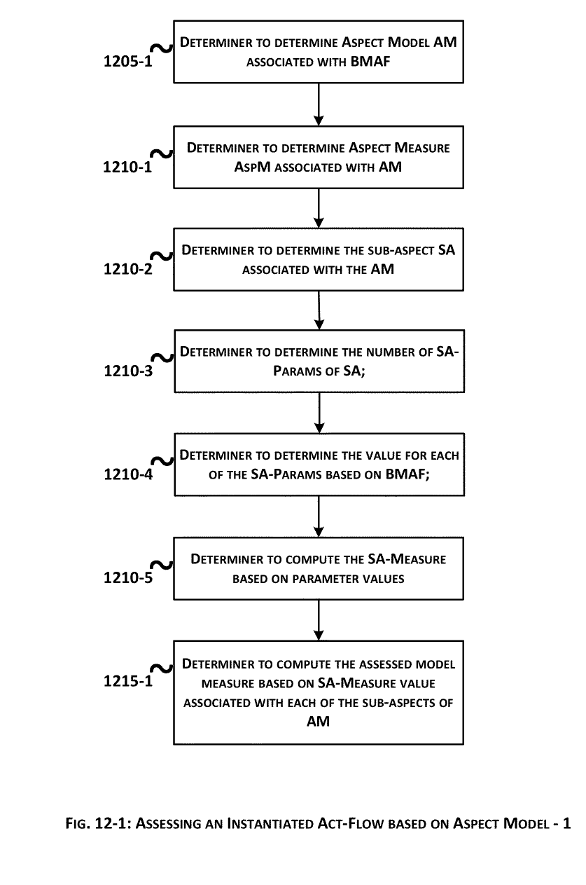

FIG. 12 provides an approach for assessing of an instantiated act-flow based on Aspect Model. The best matching act-flow, BMAF, forms the input and the output is the assessed act-flow (1200). Determine the Aspect Model AM associated with BMAF (1205). Determine Aspect Measure AspM associated with AM and for each Sub-Aspect SA of AspM, perform the following steps (1210).

Step 1: Determine the parameters SA-Params of SA;

Step 2: Determine the value for each of the SA-Params based on BMAF;

Step 3: Compute the Sa-Measure based on parameter values;

Step 4: Make Sa-Measure a part of Parameters SP of AspM;

Compute the measure of BMAF based on SP and AspM (1215).

This measure is the assessment of Student S with respect to the activity associated with BMAF (1220).

FIG. 12-1 shows in block diagram from the sub-system comprising various means represented by reference numerals 1205-1, 1210-1, 1210-2, 1210-3, 1210-4, 1210-5, and 1215-1 for carrying out the steps 1205, 1210, and 1215 of FIG. 12.

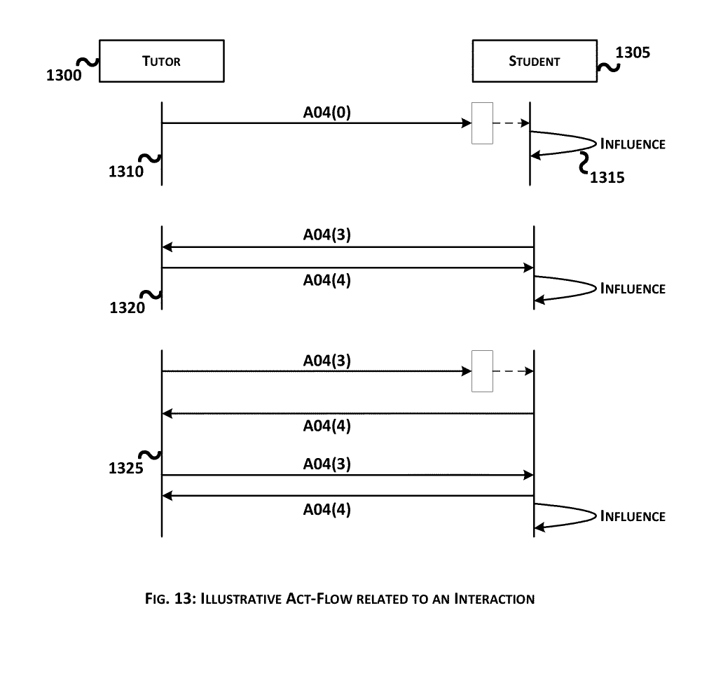

FIG. 13 depicts an illustrative act-flow related to an interaction. Consider the situation of a faculty member (1300) interacting in a classroom with a batch of students (1305). A particular sub-interaction (1310) involves the faculty member lecturing to the students (A04(0)) and this act can have an influence on a particular student that is positive, neutral, or negative (1315). As a second illustration, consider the sub-interaction (1320): the student asks a question (A04(3)) and the faculty member provides a response (A04(4)). Again, this sub-interaction results in an influencing impact on the student. Similarly, is the case of sub-interaction 1325 in which the faculty member asks a question to a student and expects a response back.

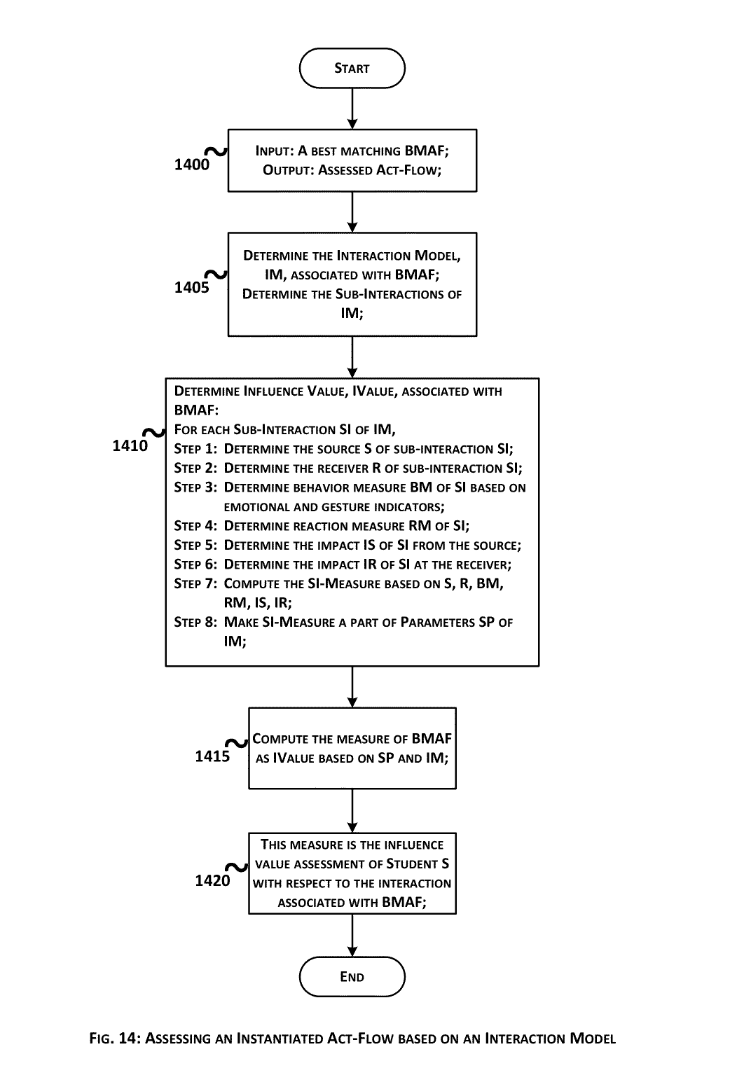

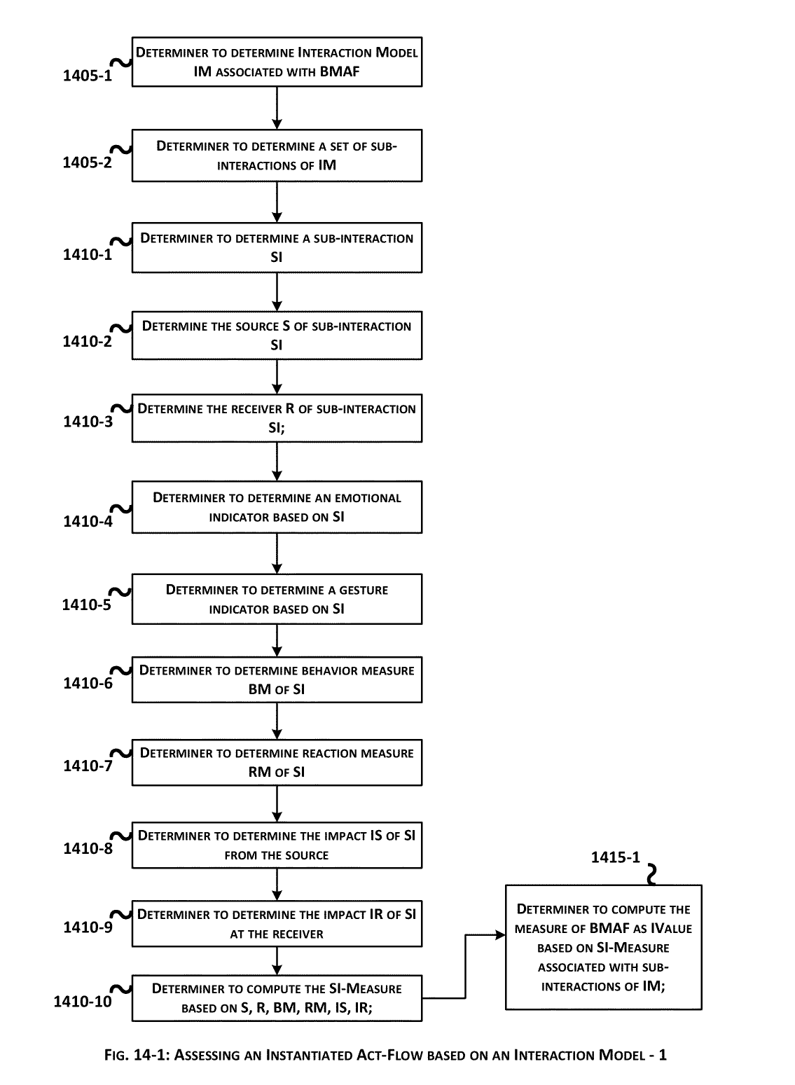

FIG. 14 provides an approach for assessing of an Instantiated act-flow based on an Interaction Model. The best matching act-flow, BMAF, forms the input and the assessed act-flow is the output (1400). Determine the Interaction Model, IM, associated with BMAF and determine the number of Sub-Interactions of IM (1405). Determine the Influence Value, IValue, associated with BMAF (1410).

For each Sub-Interaction SI of IM perform the following steps (1410).

Step 1: Determine the source S of sub-interaction SI;

Step 2: Determine the receiver R of sub-interaction SI;

Step 3: Determine behavior measure BM of SI based on emotional and gesture indicators;

Step 4: Determine reaction measure RM of SI;

Step 5: Determine the impact IS of SI from the source;

Step 6: Determine the impact IR of SI at the receiver;

Step 7: Compute the SI-Measure based on S, R, BM, RM, IS, IR;

Step 8: Make SI-Measure a part of Parameters SP of IM.

Compute the measure of BMAF as IValue based on SP and IM (1415). This measure is the influence value assessment of Student S with respect to the interaction associated with BMAF (1420).

FIG. 14-1 shows in block diagram from the sub-system comprising various means represented by reference numerals 1405-1, 1405-2, 1410-1, 1410-2, 1410-3, 1410-4, 1410-5, 1410-6, 1410-7, 1410-8, 1410-9, 1410-10, and 1415-1 for carrying out the steps 1405, 1410, and 1415 of FIG. 14.

Thus, a system and method for determining of student activity flows in a university is disclosed. Although the present invention has been described particularly with reference to the figures, it will be apparent to one of the ordinary skill in the art that the present invention may appear in any number of systems that provide for modeling of the activities based on a set of pre-defined activity flows. It is further contemplated that many changes and modifications may be made by one of ordinary skill in the art without departing from the spirit and scope of the present invention.

We claim:

1. A system for generating a plurality of assessed act-flows based on a plurality of sub-activities of a student of a university based on a plurality of act-flow models, wherein said system comprising:
a sub-system (365-1) for determining a plurality of completely traversed act-flows based on said plurality of sub-activities and said plurality of act-flow models;
a sub-system (375-1) for selecting a best matching act-flow based on said plurality of completely traversed act-flows;
a sub-system (380-1) for assessing said best matching act-flow of said plurality of act-flows based on an aspect measure associated with said best match act-flow to result in an assessed act-flow of said plurality of assessed act-flows associated with an assessed measure;
a sub-system (385-1) for assessing said best matching act-flow of said plurality of act-flows based on an aspect model associated with said best matching act-flow to result in an assessed act-flow of said plurality of assessed act-flows associated with an assessed model measure; and
a sub-system (390-1) for assessing said best matching act-flow of said plurality of act-flows based on an interaction model associated with said best matching act-flow to result in an assessed act-flow of said plurality of assessed act-flows associated with an assessed interaction measure.

2. The system of claim 1 wherein said sub-system (365-1) for determining further comprises of:
a sorter (502-1) for sorting said plurality of sub-activities with respect to a timestamp associated with a sub-activity of said plurality of sub-activities and a location stamp associated with said sub-activity to result in a plurality of sorted sub-activities;
an identifier (510-1) for identifying a plurality of act-flow related sub-activities, wherein any two sub-activities of said plurality of act-flow related sub-activities are close to each other with respect to timestamp and location stamp associated with these two sub-activities;
a determiner (520-1) for determining a plurality of open list sub-activities, wherein a timestamp of an open list sub-activity of said plurality of open list sub-activities or a location stamp of said open list sub-activity is close to a time stamp of a sub-activity of said plurality of act-flow related sub-activities or a location of stamp of said sub-activity;
a correlator (525-1) for correlating a plurality of location stamps associated with said plurality of act-flow related sub-activities and said plurality of open list sub-activities; and
a determiner (526-1) for determining said plurality of completely traversed act-flows based on said plurality of act-flow related sub-activities.

3. The system of claim 2, wherein said correlator (525-1) further comprises of:
a grouper (610-1) for clustering of said plurality of location stamps to determine a plurality of clusters and a plurality of outliers;
a determiner (615-1) for determining a maximally populated cluster based on said plurality of clusters;
a determiner (615-2) for determining a cluster location based on said maximally populated clusters;
a determiner (620-1) for obtaining an outlier location stamp of an outlier of said plurality of outliers;
a determiner (620-2) for obtaining a sub-activity associated with said outlier;
a constructor (620-3) for making said cluster location as a location stamp of said outlier, wherein a location associated with said sub-activity matches with said outlier location stamp, and making of said outlier a part of said plurality of act-flow related sub-activities.; and
a constructor (620-4) for making of said cluster location as a location stamp of said outlier based on a plurality of preceding sub-activities of said plurality of act-flow related sub-activities and a plurality of succeeding sub-activities of said plurality of act-flow related sub-activities, and making of said outlier a part of said plurality of act-flow related sub-activities.

4. The system of claim 2, wherein said determiner (526-1) further comprises of:
a determiner (705-1) for obtaining a head sub-activity from the head of said plurality of act-flow related sub-activities;
a searcher (710-1) for determining a plurality of act-flows based on said plurality of act-flow models, wherein said head sub-activity matches with an edge from the start node of an act-flow of said plurality of act-flows;
a determiner (715-1) for obtaining a sub-activity from the said plurality of act-flow related sub-activities;
a traverser (725-1) for traversing each of said plurality of act-flows based on said sub-activity; and
a determiner (735-1) for identifying a completely traversed act-flow of said plurality of completely traversed act-flows based on an act-flow of said plurality of act-flows, wherein said act-flow is traversed completely to reach a stop node of said act-flow.

5. The system of claim 4, wherein said traverser (725-1) further comprises of:
a determiner (800-1) for determining an act-flow of said plurality of act-flows and an edge of said act-flow;
a determiner (805-1) for determining of an act-id, a tag, a timestamp, a location stamp, and a mode of said sub-activity;
a determiner (805-2) for determining an edge act-id and an edge tag associated with said edge;
a checker (810-1) for checking the equality of said act-id and said edge act-id;
a similarity checker (820-1) for checking the equality of said tag and said edge tag;
a similarity checker (820-2) for checking the similarity of said tag and said edge tag, wherein a value of said edge tag is not defined; and
a similarity checker (820-3) for checking the similarity of said tag and said edge tag, wherein a value of said tag is not defined.

6. The system of claim 1, wherein said a sub-system (375-1) for selecting further comprises of:
a resolver (900) for selecting said best matching act-flow based on said plurality of completely traversed act-flows; and
a correlator (905) for correlating a plurality of modes associated with said best matching act-flow.

7. The system of claim 6, wherein said resolver (900) further comprises of:
a determiner (938-1) for determining of a completely traversed act-flow of said plurality of completely traversed act-flows;
a determiner (938-2) for computing a maximum number of edges of said completely traversed act-flow;
a determiner (938-3) for computing a number of edges of said completely traversed act-flow based on the number of edges that are matched in said completely traversed act-flow;
a determiner (938-4) for computing a number of correlated matches of said completely traversed act-flow based on the number of correlated edges of said completely traversed act-flow;
a determiner (938-5) for computing a match factor of a plurality of match factors based on said maximum number of edges, said number of edges, and said number of correlated edges; and
a determiner (940-1) for selecting said best matching act-flow based on said plurality of completely traversed act-flows and said plurality of match factors.

8. The system of claim 6, wherein said correlator (905) further comprises of:
a grouper (960-1) for clustering said plurality of modes to determine a plurality of clusters and a plurality of outliers;
a determiner (965-1) for determining a maximally populated cluster based on said plurality of clusters;
a determiner (965-2) for determining a cluster mode based on said maximally populated clusters;
a determiner (970-1) for obtaining an outlier mode of an outlier of said plurality of outliers;
a determiner (970-2) for obtaining a sub-activity associated with said outlier;
a constructor (970-3) for making of said cluster mode as a mode of said outlier, wherein said mode associated with said sub-activity matches with said outlier mode; and
a constructor (975-1) for making a mode of said best matching act-flow as said cluster mode, wherein a size of said maximally populated cluster and a size of said best matching act-flow.

9. The system of claim 1, wherein said sub-system (380-1) for assessing said best matching act-flow further comprises of:
a determiner (1005-1) for determining said aspect measure associated with said best matching act-flow;
a determiner (1005-2) for determining an edge of a plurality of edges of said best matching act-flow;
a determiner (1005-3) for determining a sub-activity associated with said edge;
a determiner (1005-4) for determining a plurality of act-params associated with said sub-activity;
a determiner (1005-5) for computing a plurality of act-param values based on said plurality of act-params and said best matching act-flow;
a determiner (1005-6) for determining an act measure associated with said sub-activity;
a determiner (1005-7) for computing an act measure value of a plurality of act measure values based said act measure and said plurality of act-param values; and
a determiner (1010-1) for computing said assessed measure based on said aspect measure and said plurality of act measure values.

10. The system of claim 1, wherein said sub-system (385-1) for assessing said best matching act-flow further comprises of:
a determiner (1205-1) for determining said aspect model associated with said best matching act-flow;
a determiner (1210-1) for determining an aspect measure associated with said aspect model;
a determiner (1210-2) for determining a sub-aspect associated with said aspect model;
a determiner (1210-3) for determining a plurality of sub-aspect-params associated with said sub-aspect;
a determiner (1210-4) for determining a plurality of sub-aspect-param values based on said plurality of sub-aspect-params and said best matching act-flow;
a determiner (1210-5) for computing of a sub-aspect measure of a plurality of sub-aspect measure values associated with said sub-aspect based on said plurality of sub-aspect param values; and
a determiner (1215-1) for computing of said assessed model measure based on said aspect measure and said plurality of sub-aspect measure values.

11. The system of claim 1, wherein said sub-system (390-1) for assessing said best matching act-flow further comprises of:
a determiner (1405-1) for determining said interaction model associated with said best matching act-flow;
a determiner (1405-2) for determining a plurality of sub-interactions of said interaction model;
a determiner (1410-1) for determining a sub-interaction of said plurality of sub-interactions;
a determiner (1410-2) for determining a source S of said sub-interaction;
a determiner (1410-3) for determining a receiver R of said sub-interaction;
a determiner (1410-4) for determining an emotional indicator based on a data associated with said sub-interaction;
a determiner (1410-5) for determining a gesture indicator based on a data associated with said sub-interaction;
a determiner (1410-6) for computing a behavior measure BM based on said emotional indicator and said gesture indicator;
a determiner (1410-7) for computing a reaction measure RM;
a determiner (1410-8) for determining a source impact IS from said source 5;
a determiner (1410-9) for determining a receiver impact IR at said receiver R;
a determiner (1410-10) for determining an SI measure of a plurality of SI measures based on said source S, said receiver R, said behavior measure BM, said reaction measure RM, said source impact IS, and said receiver impact (IR); and
a determiner (1415-1) for computing said assessed interaction measure based on said interaction model and said plurality of SI measures.
